(19) United States
(12) Patent Application Publication
(10) Pub. No.: US 2012/0254593 A1
(43) Pub. Date: Oct. 4, 2012

(54) SYSTEMS, APPARATUSES, AND METHODS FOR JUMPS USING A MASK REGISTER

(76) Inventors: Jesus Corbal San Adrian, Barcelona (ES); Bret Toll, Hillsboro, OR (US); Robert C. Valentine, Kiryat Tivon, IL (US); Milind Baburao Girkar, Sunnyvale, CA (US); Andrew Thomas Foryth, Kirkland, WA (US); George Z. Chrysos, Portland, OR (US); Edward Thomas Grochowski, San Jose, CA (US); Dennis R. Bradford, Portland, OR (US)

(21) Appl. No.: 13/078,901

(22) Filed: Apr. 1, 2011

(51) Int. Cl. G06F 9/38; G06F 9/312

(52) U.S. Cl. 712/205; 712/233; 712/E09.033; 712/E09.045

(57) ABSTRACT

Embodiments of systems, apparatuses, and methods for performing a jump instruction in a computer processor are described. In some embodiments, the execution of a blend instruction causes a conditional jump to an address of a target instruction when all of bits of a writemask are zero, wherein the address of the target instruction is calculated using an instruction pointer of the instruction and the relative offset.

### FIELD OF INVENTION

The field of invention relates generally to computer processor architecture, and, more specifically, to instructions which when executed cause a particular result.

### BACKGROUND

There are many times during program execution where a programmer desires a control flow change. Historically there have been two main types of instructions that enact control flow change: branches and jumps. A branch is usually an indication of a short change relative to the current program counter. A jump is usually an indication of a change in program counter that is not directly related to the current program counter (such as a jump to an absolute memory location or a jump using a dynamic or static table), and is often free of distance limits from the current program counter.

### BRIEF DESCRIPTION OF THE DRAWINGS

The present invention is illustrated by way of example and not limitation in the figures of the accompanying drawings, in which like references indicate similar elements and in which:

FIG. 1 illustrates an embodiment of a method for performing a JKZD instruction in a processor.

FIG. 2 illustrates another embodiment of performing a JKZD instruction in a processor.

FIG. 3 illustrates an embodiment of a method for performing a JKNZD instruction in a processor.

FIG. 4 illustrates another embodiment of performing a JKNZD instruction in a processor.

FIG. 5 illustrates an embodiment of a method for performing a JKOD instruction in a processor.

FIG. 6 illustrates another embodiment of performing a JKOD instruction in a processor.

FIG. 7 illustrates an embodiment of a method for performing a JKNOD instruction in a processor.

FIG. 8 illustrates another embodiment of performing a JKNOD instruction in a processor.

FIG. 9A is a block diagram illustrating a generic vector friendly instruction format and class A instruction templates thereof according to embodiments of the invention.

FIG. 9B is a block diagram illustrating the generic vector friendly instruction format and class B instruction templates thereof according to embodiments of the invention.

FIG. 10 is a block diagram illustrating an exemplary specific vector friendly instruction format according to embodiments of the invention.

FIG. 11 is a block diagram of a register architecture according to one embodiment of the invention.

FIG. 12A is a block diagram of a single CPU core, along with its connection to the on-die interconnect network and with its local subset of the level 2 (L2) cache, according to embodiments of the invention.

FIG. 12B is an exploded view of part of the CPU core in FIG. 12A according to embodiments of the invention.

FIG. 13 is a block diagram illustrating an exemplary out-of-order architecture according to embodiments of the invention.

FIG. 14 is a block diagram of a system in accordance with one embodiment of the invention.

FIG. 15 is a block diagram of a second system in accordance with an embodiment of the invention.

FIG. 16 is a block diagram of a third system in accordance with an embodiment of the invention.

FIG. 17 is a block diagram of a SoC in accordance with an embodiment of the invention.

FIG. 18 is a block diagram of a single core processor and a multicore processor with integrated memory controller and graphics according to embodiments of the invention.

FIG. 19 is a block diagram contrasting the use of a software instruction converter to convert binary instructions in a source instruction set to binary instructions in a target instruction set according to embodiments of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

### Jump Instructions

Detailed below are several embodiments of several jump instructions and embodiments of systems, architectures, instruction formats etc. that may be used to execute such instructions. These jump instructions may be used to conditionally change the control flow sequence of a program based on the values of a writemask included with the instruction. These instructions utilize a “writemask” change the control flow of vectorized code where every bit of the mask relates to one SIMD-filed instance of control flow information—a loop iteration. Details of embodiments of writemasks are detailed later.

The typical uses of the jump instructions below include: early escape on loops with dynamic convergence; iterating until all active elements are off (e.g., motion estimation diamond search and finite difference algorithms); suppression of faux memory faults when the mask is zero; improved performance of gather/scatter instructions; and to save work for sparsely populated predicated code (e.g., a compiler cannot afford to compress/expand in memory).

Most instances of control flow based on a writemask are either: jump when the writemask is all zeros or jump when mask in not all zeros. A table illustrating an exemplary high-level language pseudo code and its pseudo assembly counterpart are illustrated below. The VCMPPS instruction compares data elements of the source registers ZMM1 and ZMM2 and stores them as “mask” bits in the writemask k1 based if the data element of ZMM1 is less than the corresponding data element of ZMM2. Of course, VCMPPS is not limited to such a scenario and could evaluate based on other conditions such as equal, less than or equal, unordered, no equal, not less than, not less than or equal, or ordered for example.

TABLE 1

| Pseudo Code | JNZ Approach |
|---|---|
| for(i=0; i<16; i++) | loop_not_finished: |
| { | VMOVAPS zmm1, a // load a |
| not_finished = TRUE; | VMOVAPS zmm2, b // load b |
| while(not_finished) | VSUBPS zmm1, zmm1, |
| { | zmm2 // a[i] = |
| a[i] = a[i] − b[i]; | a[i] − b[i] |
| if(a[i] < b[i]) not_finished = | VCMPPS k1, zmm1, zmm2, |
| FALSE; | LT // k1[i] = |
| } | (a[i]<b[i])? 1 : 0 |
| }z | KORTESTD k1, k1 |
| | JNZ loop_not_finished |

The JNZ approach for such a sequence is relatively slow and requires two instructions two jump out of the loop after a writemask has been generated:

KORTEST k1, k1 // (OR(k1,k1)==0x0)=>ZF
JNZ target_addr

The KORTEST instruction performs an “OR” operation of two masks and if the result is a zero, then the zero flag in the “condition code” or status register (such as FLAGS or EFLAGS) is set. The JNZ (jump not zero) instruction looks at that flag and jumps to the target address if the zero flag has been set. Therefore there is an opportunity to reduce throughput and (in the future) latency to this software sequence.

### JKZD—Jump Near if the Writemask is Zero

The first instruction to be discussed is a jump near if the writemask is zero (JKZD). The execution of this instruction by a processor causes the values of a source writemask to be checked to see if all of its writemask bits are set to “0,” and if so, to cause the processor to perform a jump to a target instruction at least in part specified by the destination operand and the current instruction pointer. If all of the writemask bits are not “0” (and therefore the jump condition is not satisfied), no jump is performed and execution continues with the instruction following the JKZD instruction.

The JKZD's target instruction's address is typically specified with a relative offset operand (a signed offset relative to the current value of the instruction pointer in the EIP register) included in the instruction. The relative offset (rel8, rel16, or rel32) is generally specified as a label in assembly code, but at the machine code level, it may be encoded as a signed 8- or 32-bit immediate value, which is added to the instruction pointer. Typically, instruction coding is most efficient for offsets of −128 to 127. In some embodiments, if the operand size (instruction pointer) is 16 bits, then the upper two bytes of the EIP register are not used (cleared) to generated the target instruction address. In some embodiments, in 64-bit mode with a 64-bit operand size (RIP stores the instruction pointer), a jump short's target instruction address is defined as RIP=RIP+8-bit offset sign extended to 64 bits. In this mode a jump near's target address is defined as RIP=RIP+32-bit offset extended to 64 bits.

An exemplary format of this instruction is “JKZD k1, rel8/32,” where k1 is a writemask operand (such as a 16-bit register like those detailed earlier) and rel8/32 is an immediate value of either 8 or 32 bits. In some embodiments, the writemask is of a different size (8 bits, 32 bits, etc.). JKZD is the instruction's opcode. Typically, each operand is explicitly defined in the instruction. In other embodiments the immediate value is a different size such as 16 bits.

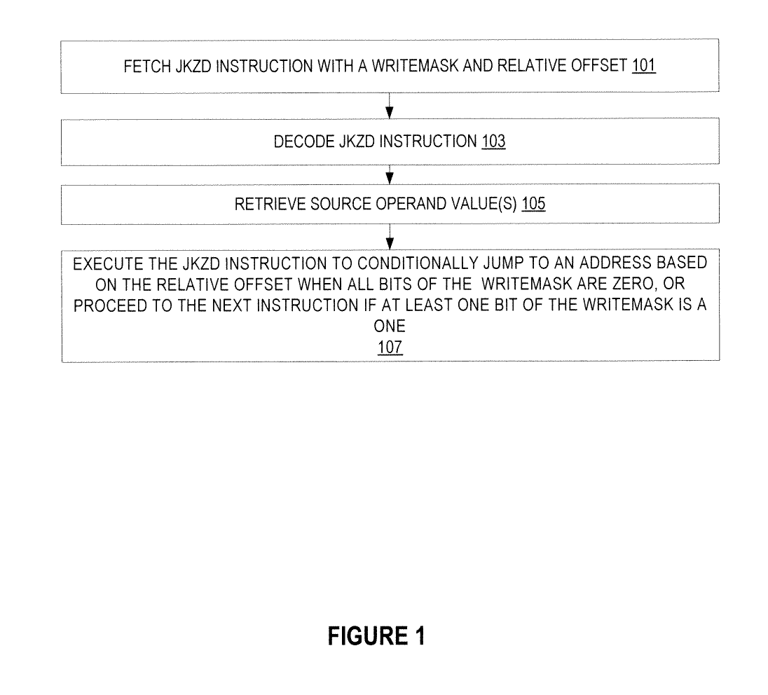

FIG. 1 illustrates an embodiment of a method for performing a JKZD instruction in a processor. The JKZD instruction including a writemask and relative offset is fetched at 101.

The JKZD instruction is decoded at 103 and source operand values such as the writemask are retrieved at 105.

The decoded JKZD instruction is executed at 107 which causes a conditional jump to an instruction at an address generated from the relative offset and current instruction pointer when all of the bits of the writemask are zero or causes the instruction following the JKZD instruction to be fetched, decoded, etc. if at least one bit of the writemask is a one. The generation of the address may occur in any of the decoding, retrieval, or execution phases of this method.

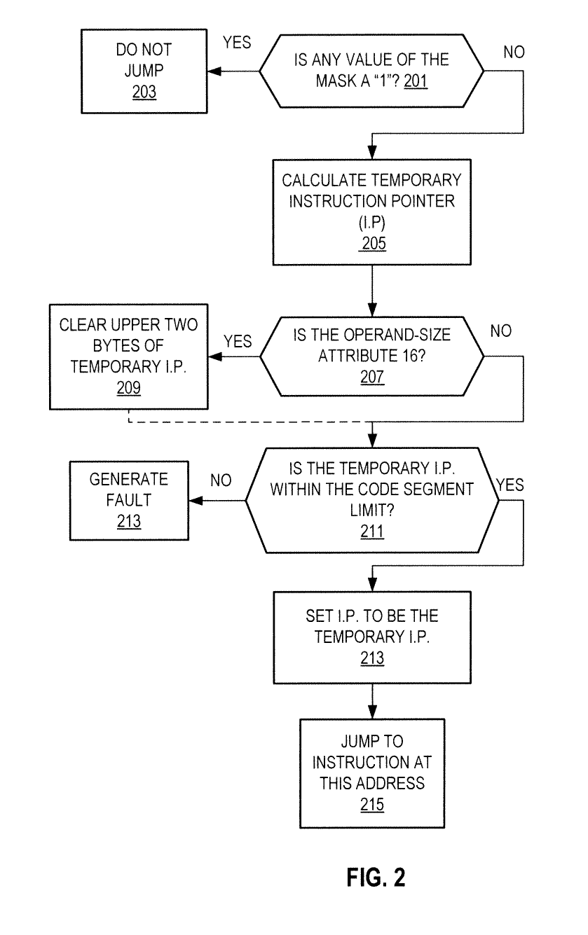

FIG. 2 illustrates another embodiment of performing a JKZD instruction in a processor. It is assumed that some of 101-105 have been performed prior the beginning of this method and they are not shown to not obscure the proceeding details. At 201 a determination of if there is any “1” value in the writemask is made.

If there is a “1” in the writemask (and therefore the writemask is not a zero), then the jump is not executed and the sequential instruction in the program's flow is executed at 203. If there was not a “1” in the writemask, a temporary instruction pointer is generated at 205. In some embodiments, this temporary instruction pointer is the current instruction pointer plus the sign extended relative offset. For example, with a 32-bit instruction pointer the value of the temporary instruction pointer is EIP plus the sign extended relative offset. This temporary instruction pointer may be stored in a register.

A determination of if the operand size attribute is 16 bits is made at 207. For example, is the instruction pointer a 16-, 32-, or 64-bit value? If the operand size attribute is 16-bit, then the upper two bytes of the temporary instruction pointer are cleared (set to zero) at 209. The clearing may occur in several different manners, but in some embodiments the temporary instruction pointer is logically ANDed with an immediate having the most significant two bytes as “0” and the least significant two bytes as “1” (e.g., the immediate is 0x0000FFFF).

If the operand size is not 16-bit, then a determination of if the temporary instruction pointer is within the code segment limit is made at 211.

If it is not, then a fault is generated at 213 and the jump will not performed. This determination may also be made for a temporary instruction pointer with the two most significant bytes cleared. In some embodiments where the instruction does not support far jumps (jumps to other code segments), when the target for the conditional jump is in a different segment, the opposite condition from the condition being tested for the JKZD instruction is used, and then the target is accessed with an unconditional far jump (JMP instruction) to the other segment. In embodiments that have jump limitations, if a program wanted to jump to far regions of code, then what the semantics of the writemask-on-jump are negated to make the follow-through code to do a “far” jump into the specific code. For example, this condition would be illegal:

### JKZD FARLABEL;

To accomplish this far jump, use the following two instructions would be used instead:

### JKNZD BEYOND;

### JMP FARLABEL;

### BEYOND:

If the temporary instruction pointer is within the code segment limit, then the instruction pointer is set to be the temporary instruction pointer at 213. For example, the EIP value is set to be the temporary instruction pointer. The jump is made at 215.

Finally, in some embodiments, one or more of the above aspects of the method are not performed or performed in a different order. For example, if the processor does not have 16-bit operands (instruction pointers) then that decision would not occur.

Table 2 illustrates the same pseudo code of Table 1, but utilizes the JKNZD instruction and eliminates the need for KORTESTD. A similar benefit will occur for the following instructions.

TABLE 2

| Pseudo Code | JNZ Approach |
|---|---|
| for(i=0; i<16; i++) | loop_not_finished: |
| { | VMOVAPS zmm1, a // load a |
| not_finished = TRUE; | VMOVAPS zmm2, b // load b |
| while(not_finished) | VSUBPS zmm1, zmm1, zmm2 |
| { | // a[i] = a[i] − b[i] |
| a[i] = a[i] − b[i]; | VCMPPS k1, zmm1, zmm2, LT |
| if(a[i] < b[i]) not_finished = | // k1[i] = (a[i]<b[i])? |
| FALSE; | 1 : 0 |
| } | JKNZD k1, loop_not_finished |
| } | |

### JKNZD—Jump Near if the Writemask is not Zero

The second instruction to be discussed is a jump near if the writemask is not zero (JKNZD). The execution of this instruction by a processor causes the values of source writemask to be checked to see if all of its writemask bits are set to “0,” and if not, to cause the processor to perform a jump to a target instruction at least in part specified by the destination operand and the current instruction pointer. If all of the writemask bits are “0” (and therefore the jump condition is not satisfied), no jump is performed and execution continues with the instruction following the JKNZD instruction.

The JKNZD's target instruction's address is typically specified with a relative offset operand (a signed offset relative to the current value of the instruction pointer in the EIP register) included in the instruction. The relative offset (rel8, rel16, or rel32) is generally specified as a label in assembly code, but at the machine code level, it may be encoded as a signed 8- or 32-bit immediate value, which is added to the instruction pointer. Typically, instruction coding is most efficient for offsets of −128 to 127. In some embodiments, if the operand size (instruction pointer) is 16 bits, then the upper two bytes of the EIP register are not used (cleared) to generated the target instruction address. In some embodiments, in 64-bit mode with a 64-bit operand size (RIP stores the instruction pointer), a jump short's target instruction address is defined as RIP=RIP+8-bit offset sign extended to 64 bits. In this mode a jump near's target address is defined as RIP=RIP+32-bit offset extended to 64-bits.

An exemplary format of this instruction is “JKNZD k1, rel8/32,” where k1 is a writemask operand (such as a 16-bit register like those detailed earlier) and rel8/32 is an immediate value of either 8 or 32 bits. In some embodiments, the writemask is of a different size (8 bits, 32 bits, etc.). JKBZD is the instruction's opcode. Typically, each operand is explicitly defined in the instruction. In other embodiments the immediate value is a different size such as 16 bits.

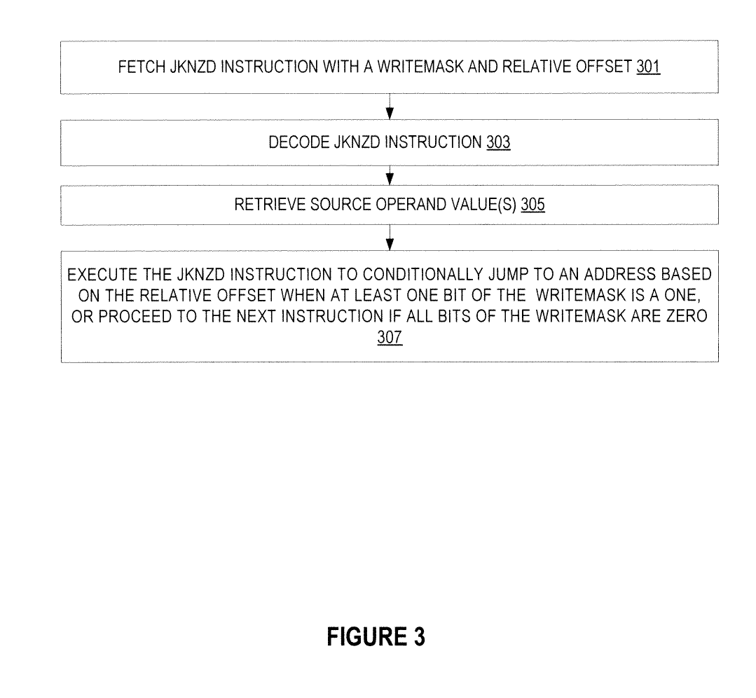

FIG. 3 illustrates an embodiment of a method for performing a JKNZD instruction in a processor. The JKNZD instruction including a writemask and relative offset is fetched at 301.

The JKNZD instruction is decoded at 303 and source operand values such as the writemask are retrieved at 305.

The decoded JKNZD instruction is executed at 307 which causes a conditional jump to an instruction at an address generated from the relative offset and current instruction pointer when all of the bits of the writemask are zero or causes the instruction following the JKNZD instruction to be fetched, decoded, etc. if at least one bit of the writemask is a one. The generation of the address may occur in any of the decoding, retrieval, or execution phases of this method.

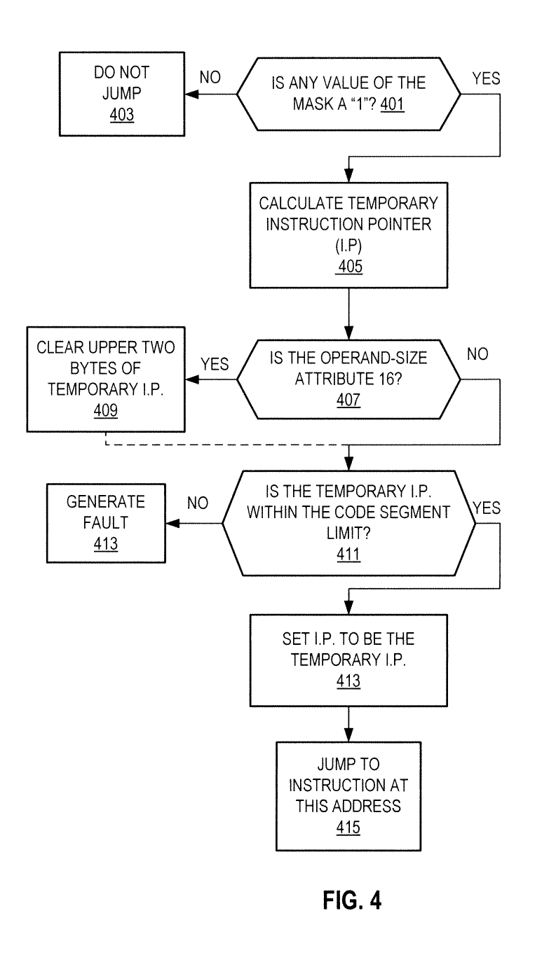

FIG. 4 illustrates another embodiment of performing a JKNZD instruction in a processor. It is assumed that some of 401-405 have been performed prior the beginning of this method and they are not shown to not obscure the proceeding details. At 401 a determination of if there is any “1” value in the writemask is made.

If there are only “0s” in the writemask (and therefore the writemask is a zero), then the jump is not executed and the sequential instruction in the program's flow is executed at 403. If there is a “1” in the writemask, a temporary instruction pointer is generated at 405. In some embodiments, this temporary instruction pointer is the current instruction pointer plus the sign extended relative offset. For example, with a 32-bit instruction pointer the value of the temporary instruction pointer is EIP plus the sign extended relative offset. This temporary instruction pointer may be stored in a register.

A determination of if the operand size attribute is 16 bits is made at 407. For example, is the instruction pointer a 16-, 32-, or 64-bit value. If the operand size attribute is 16-bit, then the upper two bytes of the temporary instruction pointer are cleared (set to zero) at 409. The clearing may occur in several different manners, but in some embodiments the temporary instruction pointer is logically ANDed with an immediate having the most significant two bytes as “0” and the least significant two bytes at “1” (e.g., the immediate is 0x0000FFFF).

If the operand size is not 16-bit, then a determination of if the temporary instruction pointer is within the code segment limit is made at 411. If it is not, then a fault is generated at 413 and the jump will not performed. This determination may also be made for a temporary instruction pointer with the two most significant bytes cleared. In some embodiments where the instruction does not support far jumps (jumps to other code segments), when the target for the conditional jump is in a different segment, the opposite condition from the condition being tested for the JKNZD instruction is used, and then the target is accessed with an unconditional far jump (JMP instruction) to the other segment. For example, this condition would be illegal:

### JKNZD FARLABEL;

To accomplish this far jump, use the following two instructions would be used instead:

### JKZD BEYOND;

### JMP FARLABEL;

### BEYOND:

If the temporary instruction pointer is within the code segment limit, then the instruction pointer is set to be the temporary instruction pointer at 413. For example, the EIP value is set to be the temporary instruction pointer. The jump is made at 415.

Finally, in some embodiments, one or more of the above aspects of the method are not performed or performed in a different order. For example, if the processor does not have 16-bit operands (instruction pointers) then that decision would not occur.

### JKOD—Jump Near if the Writemask is all Ones

The third instruction to be discussed is a jump near if the writemask is all ones (JKOD). The execution of this instruction by a processor causes the values of source writemask to be checked to see if all of its writemask bits are set to “1,” and if so, to cause the processor to perform a jump to a target instruction at least in part specified by the destination operand and the current instruction pointer. If all of the writemask bits are not “1” (and therefore the jump condition is not satisfied), no jump is performed and execution continues with the instruction following the JKOD instruction.

The JKOD's target instruction's address is typically specified with a relative offset operand (a signed offset relative to the current value of the instruction pointer in the EIP register) included in the instruction. The relative offset (rel8, rel16, or rel32) is generally specified as a label in assembly code, but at the machine code level, it may be encoded as a signed 8- or 32-bit immediate value, which is added to the instruction pointer. Typically, instruction coding is most efficient for offsets of −128 to 127. In some embodiments, if the operand size (instruction pointer) is 16 bits, then the upper two bytes of the EIP register are not used (cleared) to generated the target instruction address. In some embodiments, in 64-bit mode with a 64-bit operand size (RIP stores the instruction pointer), a jump short's target instruction address is defined as RIP=RIP+8-bit offset sign extended to 64 bits. In this mode a jump near's target address is defined as RIP=RIP+32-bit offset extended to 64-bits.

An exemplary format of this instruction is “JKOD k1, rel8/32,” where k1 is a writemask operand (such as a 16-bit register like those detailed earlier) and rel8/32 is an immediate value of either 8 or 32 bits. In some embodiments, the writemask is of a different size (8 bits, 32 bits, etc.). JKOD is the instruction's opcode. Typically, each operand is explicitly defined in the instruction. In other embodiments the immediate value is a different size such as 16 bits.

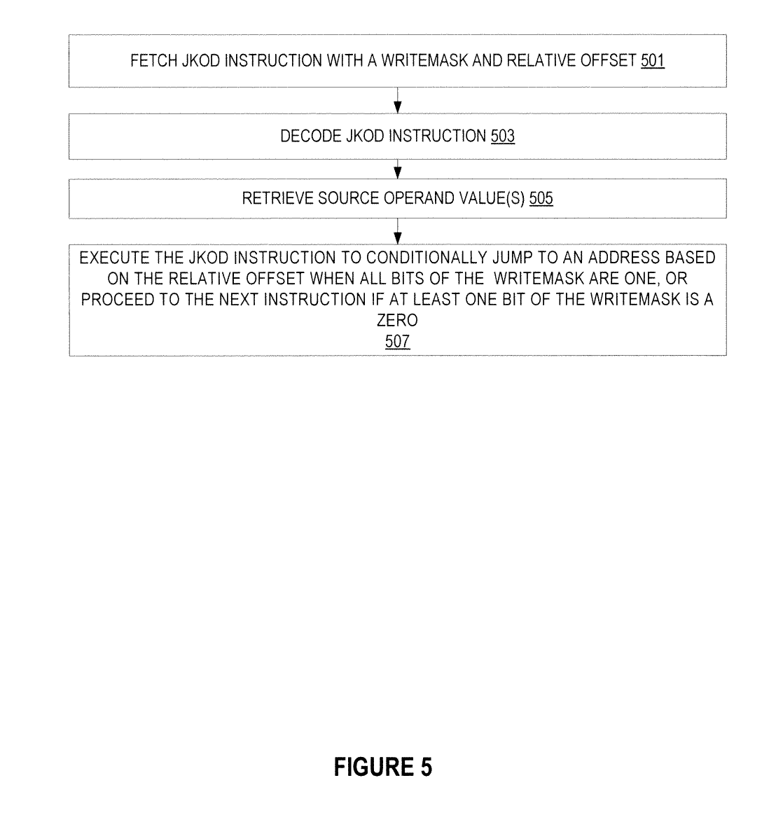

FIG. 5 illustrates an embodiment of a method for performing a JKOD instruction in a processor. The JKOD instruction including a writemask and relative offset is fetched at 501.

The JKOD instruction is decoded at 503 and source operand values such as the writemask are retrieved at 505.

The decoded JKOD instruction is executed at 507 which causes a conditional jump to an instruction at an address generated from the relative offset and current instruction pointer when all of the bits of the writemask are one or causes the instruction following the JKOD instruction to be fetched, decoded, etc. if at least one bit of the writemask is a zero. The generation of the address may occur in any of the decoding, retrieval, or execution phases of this method.

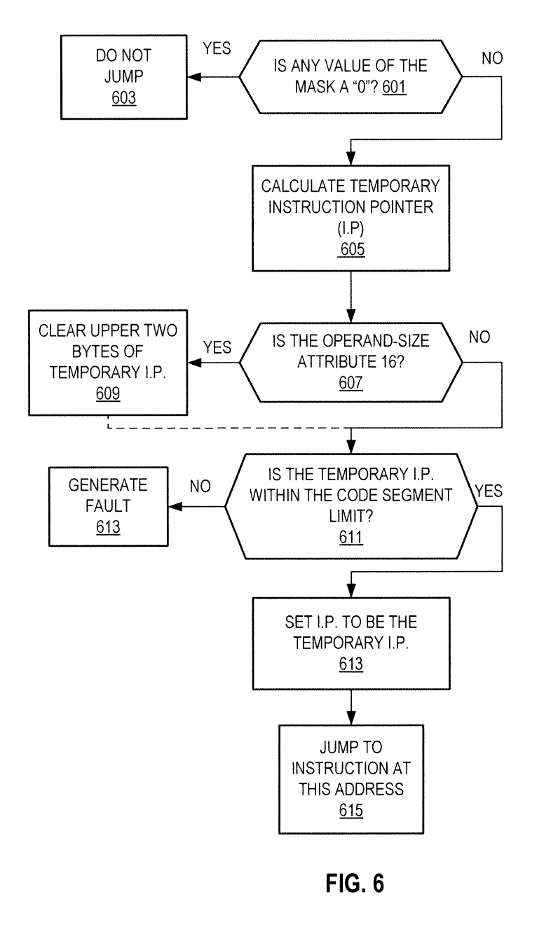

FIG. 6 illustrates another embodiment of performing a JKOD instruction in a processor. It is assumed that some of the 601-605 have been performed prior the beginning of this method and they are not shown to not obscure the proceeding details. At 601 a determination of if there is any “0” value in the writemask is made.

If there is a “0” in the writemask (and therefore the writemask is not all ones), then the jump is not executed and the sequential instruction in the program's flow is executed at 603. If there was not a “0” in the writemask, a temporary instruction pointer is generated at 605. In some embodiments, this temporary instruction pointer is the current instruction pointer plus the sign extended relative offset. For example, with a 32-bit instruction pointer the value of the temporary instruction pointer is EIP plus the sign extended relative offset. This temporary instruction pointer may be stored in a register.

A determination of if the operand size attribute is 16 bits is made at 607. For example, is the instruction pointer a 16-, 32-, or 64-bit value. If the operand size attribute is 16-bit, then the upper two bytes of the temporary instruction pointer are cleared (set to zero) at 609. The clearing may occur in several different manners, but in some embodiments the temporary instruction pointer is logically ANDed with an immediate having the most significant two bytes as “0” and the least significant two bytes at “1” (e.g., the immediate is 0x0000FFFF).

If the operand size is not 16-bit, then a determination of if the temporary instruction pointer is within the code segment limit is made at 611. If it is not, then a fault is generated at 613 and the jump will not performed. This determination may also be made for a temporary instruction pointer with the two most significant bytes cleared.

If the temporary instruction pointer is within the code segment limit, then the instruction pointer is set to be the temporary instruction pointer at 613. For example, the EIP value is set to be the temporary instruction pointer. The jump is made at 615.

Finally, in some embodiments, one or more of the above aspects of the method are not performed or performed in a different order. For example, if the processor does not have 16-bit operands (instruction pointers) then that decision would not occur.

### JKNOD—Jump Near if the Writemask is not all Ones

The final instruction to be discussed is a jump near if the writemask is not all ones (JKNOD). The execution of this instruction by a processor causes the values of source writemask to be checked to see if at least one writemask bit are set to “0,” and if yes, to cause the processor to perform a jump to a target instruction at least in part specified by the destination operand and the current instruction pointer. If none of the writemask bits are “0” (and therefore the jump condition is not satisfied), no jump is performed and execution continues with the instruction following the JKNOD instruction.

The JKNOD's target instruction's address is typically specified with a relative offset operand (a signed offset relative to the current value of the instruction pointer in the EIP register) included with the instruction. The relative offset (rel8, rel16, or rel32) is generally specified as a label in assembly code, but at the machine code level, it may be encoded as a signed 8- or 32-bit immediate value, which is added to the instruction pointer. Typically, instruction coding is most efficient for offsets of −128 to 127. In some embodiments, if the operand size (instruction pointer) is 16 bits, then the upper two bytes of the EIP register are not used (cleared) to generated the target instruction address. In some embodiments, in 64-bit mode with a 64-bit operand size (RIP stores the instruction pointer), a jump short's target instruction address is defined as RIP=RIP+8-bit offset sign extended to 64 bits. In this mode a jump near's target address is defined as RIP=RIP+32-bit offset extended to 64-bits.

An exemplary format of this instruction is “JKNOD k1, rel8/32,” where k1 is a writemask operand (such as a 16-bit register like those detailed earlier) and rel8/32 is an immediate value of either 8 or 32 bits. In some embodiments, the writemask is of a different size (8 bits, 32 bits, etc.). JKNOD is the instruction's opcode. Typically, each operand is explicitly defined in the instruction. In other embodiments the immediate value is a different size such as 16 bits.

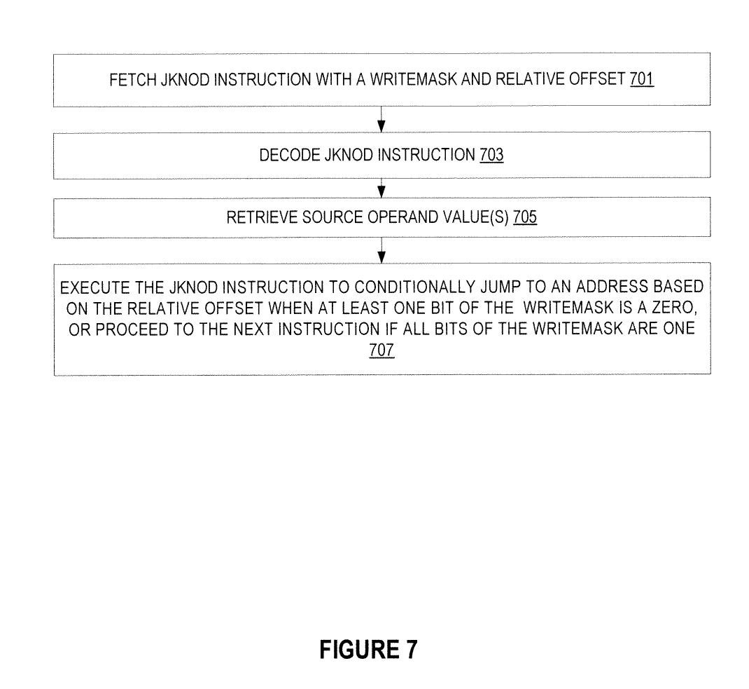

FIG. 7 illustrates an embodiment of a method for performing a JKNOD instruction in a processor. The JKNOD instruction including a writemask and relative offset is fetched at 701.

The JKNOD instruction is decoded at 703 and source operand values such as the writemask are retrieved at 305.

The decoded JKNOD instruction is executed at 307 which causes a conditional jump to an instruction at an address generated from the relative offset and current instruction pointer when at least one of the bits of the writemask is not one or causes the instruction following the JKNZD instruction to be fetched, decoded, etc. if all bits of the writemask are a one. The generation of the address may occur in any of the decoding, retrieval, or execution phases of this method.

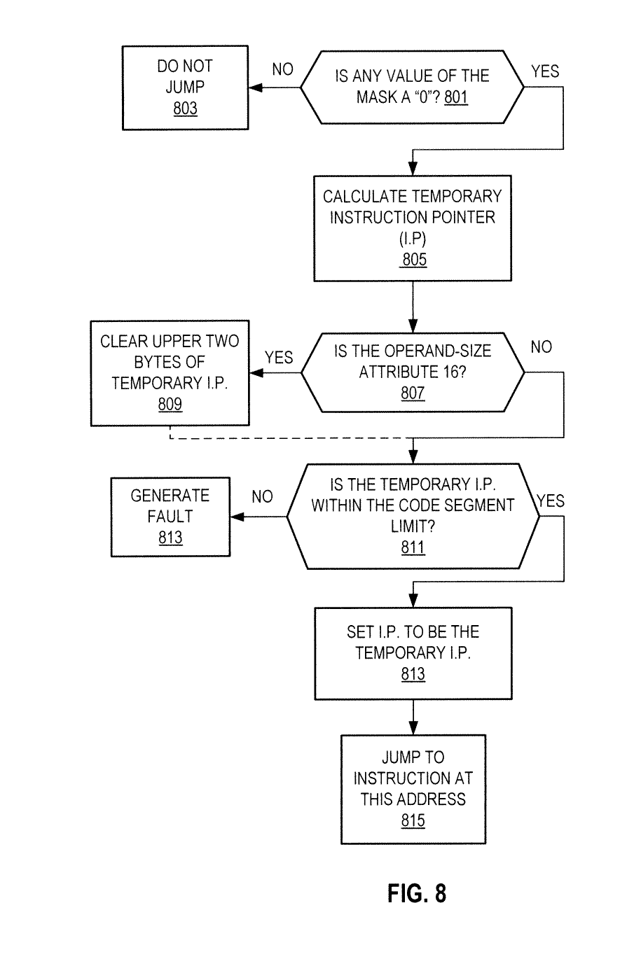

FIG. 8 illustrates another embodiment of performing a JKNOD instruction in a processor. It is assumed that some of the 701-705 have been performed prior the beginning of this method and they are not shown to not obscure the proceeding details. At 801 a determination of if there is any “0” value in the writemask is made.

If there is not a “0” in the writemask and therefore the writemask is all ones), then the jump is not executed and the sequential instruction in the program's flow is executed at 803. If there is a “0” in the writemask, a temporary instruction pointer is generated at 805. In some embodiments, this temporary instruction pointer is the current instruction pointer plus the sign extended relative offset. For example, with a 32-bit instruction pointer the value of the temporary instruction pointer is EIP plus the sign extended relative offset. This temporary instruction pointer may be stored in a register.

A determination of if the operand size attribute is 16 bits is made at 807. For example, is the instruction pointer a 16-, 32-, or 64-bit value. If the operand size attribute is 16-bit, then the upper two bytes of the temporary instruction pointer are cleared (set to zero) at 809. The clearing may occur in several different manners, but in some embodiments the temporary instruction pointer is logically ANDed with an immediate having the most significant two bytes as “0” and the least significant two bytes at “1” (e.g., the immediate is 0x0000FFFF).

If the operand size is not 16-bit, then a determination of if the temporary instruction pointer is within the code segment limit is made at 811. If it is not, then a fault is generated at 813 and the jump will not performed. This determination may also be made for a temporary instruction pointer with the two most significant bytes cleared.

If the temporary instruction pointer is within the code segment limit, then the instruction pointer is set to be the temporary instruction pointer at 813. For example, the EIP value is set to be the temporary instruction pointer. The jump is made at 815.

Finally, in some embodiments, one or more of the above aspects of the method are not performed or performed in a different order. For example, if the processor does not have 16-bit operands (instruction pointers) then that decision would not occur.

Embodiments of the instruction(s) detailed above are embodied may be embodied in a “generic vector friendly instruction format” which is detailed below. In other embodiments, such a format is not utilized and another instruction format is used, however, the description below of the writemask registers, various data transformations (swizzle, broadcast, etc.), addressing, etc. is generally applicable to the description of the embodiments of the instruction(s) above. Additionally, exemplary systems, architectures, and pipelines are detailed below. Embodiments of the instruction(s) above may be executed on such systems, architectures, and pipelines, but are not limited to those detailed.

A vector friendly instruction format is an instruction format that is suited for vector instructions (e.g., there are certain fields specific to vector operations). While embodiments are described in which both vector and scalar operations are supported through the vector friendly instruction format, alternative embodiments use only vector operations the vector friendly instruction format.

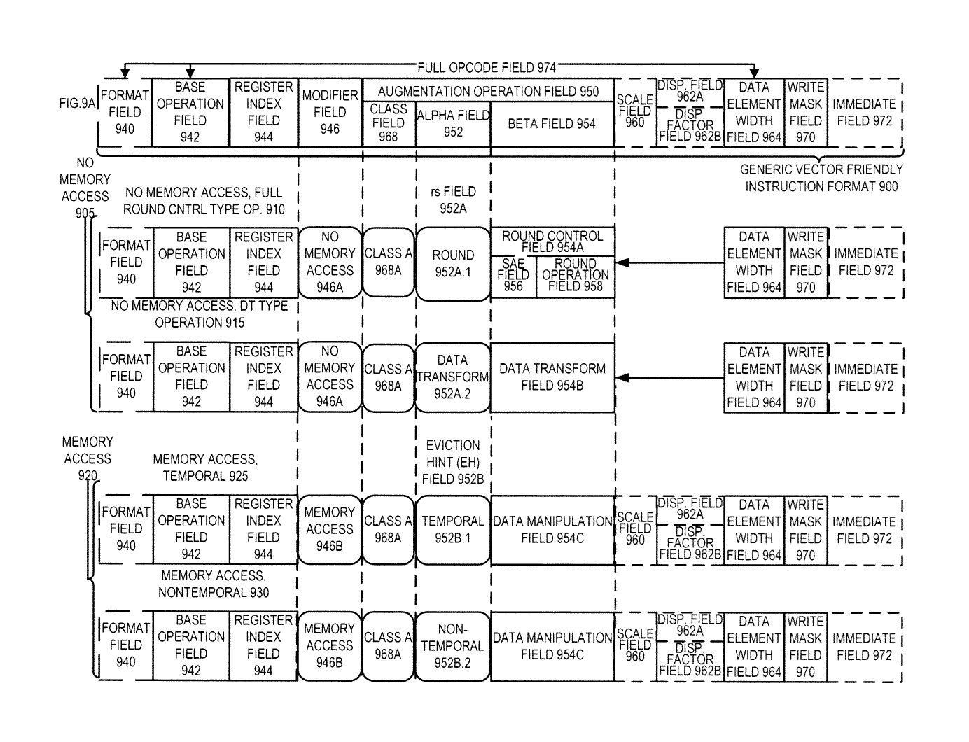

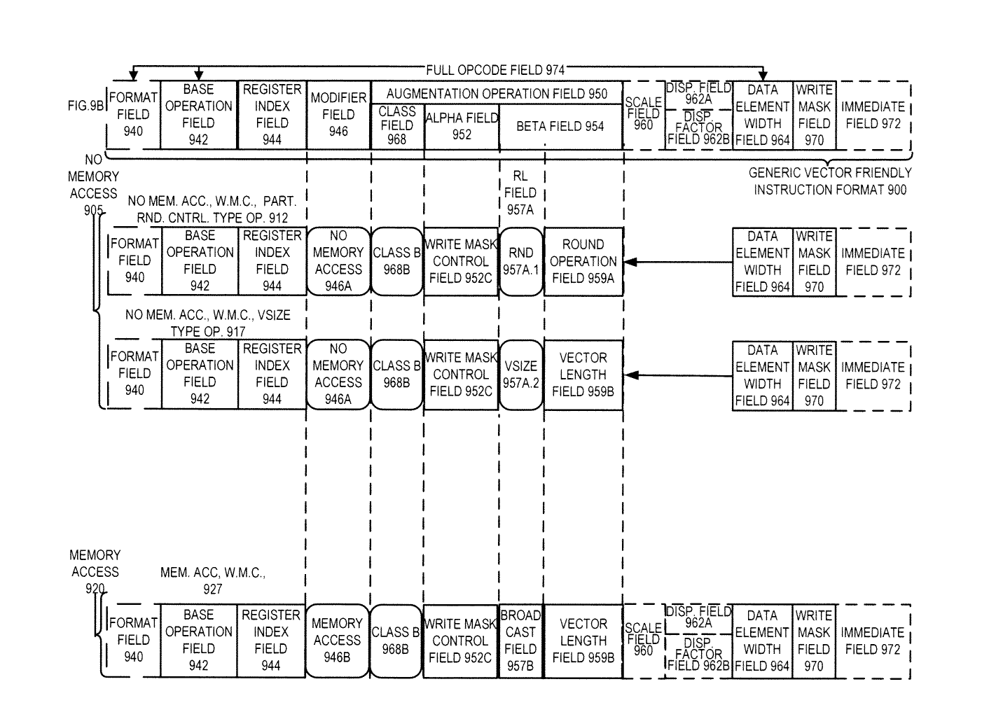

Exemplary Generic Vector Friendly Instruction Format—FIG. 9A-B

FIGS. 9A-B are block diagrams illustrating a generic vector friendly instruction format and instruction templates thereof according to embodiments of the invention. FIG. 9A is a block diagram illustrating a generic vector friendly instruction format and class A instruction templates thereof according to embodiments of the invention; while FIG. 9B is a block diagram illustrating the generic vector friendly instruction format and class B instruction templates thereof according to embodiments of the invention. Specifically, a generic vector friendly instruction format 900 for which are defined class A and class B instruction templates, both of which include no memory access 905 instruction templates and memory access 920 instruction templates. The term generic in the context of the vector friendly instruction format refers to the instruction format not being tied to any specific instruction set. While embodiments will be described in which instructions in the vector friendly instruction format operate on vectors that are sourced from either registers (no memory access 905 instruction templates) or registers/memory (memory access 920 instruction templates), alternative embodiments of the invention may support only one of these. Also, while embodiments of the invention will be described in which there are load and store instructions in the vector instruction format, alternative embodiments instead or additionally have instructions in a different instruction format that move vectors into and out of registers (e.g., from memory into registers, from registers into memory, between registers). Further, while embodiments of the invention will be described that support two classes of instruction templates, alternative embodiments may support only one of these or more than two.

While embodiments of the invention will be described in which the vector friendly instruction format supports the following: a 64 byte vector operand length (or size) with 32 bit (4 byte) or 64 bit (8 byte) data element widths (or sizes) (and thus, a 64 byte vector consists of either 16 doubleword-size elements or alternatively, 8 quadword-size elements); a 64 byte vector operand length (or size) with 16 bit (2 byte) or 8 bit (1 byte) data element widths (or sizes); a 32 byte vector operand length (or size) with 32 bit (4 byte), 64 bit (8 byte), 16 bit (2 byte), or 8 bit (1 byte) data element widths (or sizes); and a 16 byte vector operand length (or size) with 32 bit (4 byte), 64 bit (8 byte), 16 bit (2 byte), or 8 bit (1 byte) data element widths (or sizes); alternative embodiments may support more, less and/or different vector operand sizes (e.g., 956 byte vector operands) with more, less, or different data element widths (e.g., 128 bit (16 byte) data element widths).

The class A instruction templates in FIG. 9A include: 1) within the no memory access 905 instruction templates there is shown a no memory access, full round control type operation 910 instruction template and a no memory access, data transform type operation 915 instruction template; and 2) within the memory access 920 instruction templates there is shown a memory access, temporal 925 instruction template and a memory access, non-temporal 930 instruction template. The class B instruction templates in FIG. 9B include: 1) within the no memory access 905 instruction templates there is shown a no memory access, write mask control, partial round control type operation 912 instruction template and a no memory access, write mask control, vsize type operation 917 instruction template; and 2) within the memory access 920 instruction templates there is shown a memory access, write mask control 927 instruction template.

Format

The generic vector friendly instruction format 900 includes the following fields listed below in the order illustrated in FIGS. 9A-B.

Format field 940—a specific value (an instruction format identifier value) in this field uniquely identifies the vector friendly instruction format, and thus occurrences of instructions in the vector friendly instruction format in instruction streams. Thus, the content of the format field 940 distinguish occurrences of instructions in the first instruction format from occurrences of instructions in other instruction formats, thereby allowing for the introduction of the vector friendly instruction format into an instruction set that has other instruction formats. As such, this field is optional in the sense that it is not needed for an instruction set that has only the generic vector friendly instruction format.

Base operation field 942—its content distinguishes different base operations. As described later herein, the base operation field 942 may include and/or be part of an opcode field.

Register index field 944—its content, directly or through address generation, specifies the locations of the source and destination operands, be they in registers or in memory. These include a sufficient number of bits to select N registers from a PxQ (e.g. 32x1112) register file. While in one embodiment N may be up to three sources and one destination register, alternative embodiments may support more or less sources and destination registers (e.g., may support up to two sources where one of these sources also acts as the destination, may support up to three sources where one of these sources also acts as the destination, may support up to two sources and one destination). While in one embodiment P=32, alternative embodiments may support more or less registers (e.g., 16). While in one embodiment Q=1112 bits, alternative embodiments may support more or less bits (e.g., 128, 1024).

Modifier field 946—its content distinguishes occurrences of instructions in the generic vector instruction format that specify memory access from those that do not; that is, between no memory access 905 instruction templates and memory access 920 instruction templates. Memory access operations read and/or write to the memory hierarchy (in some cases specifying the source and/or destination addresses using values in registers), while non-memory access operations do not (e.g., the source and destinations are registers). While in one embodiment this field also selects between three different ways to perform memory address calculations, alternative embodiments may support more, less, or different ways to perform memory address calculations.

Augmentation operation field 950—its content distinguishes which one of a variety of different operations to be performed in addition to the base operation. This field is context specific. In one embodiment of the invention, this field is divided into a class field 968, an alpha field 952, and a beta field 954. The augmentation operation field allows common groups of operations to be performed in a single instruction rather than 2, 3 or 4 instructions. Below are some examples of instructions (the nomenclature of which are described in more detail later herein) that use the augmentation field 950 to reduce the number of required instructions.

| | Instructions Sequences according to on |
|---|---|
| Prior Instruction Sequences | Embodiment of the Invention |
| vaddps ymm0, ymm1, ymm2 | vaddps zmm0, zmm1, zmm2 |
| vpshufd ymm2, ymm2, 0x55 | vaddps zmm0, zmm1, zmm2 {bbbb} |
| vaddps ymm0, ymm1, ymm2 | |
| vpmovsxbd ymm2, [rax] | vaddps zmm0, zmm1, [rax]{sint8} |
| vcvtdq2ps ymm2, ymm2 | |
| vaddps ymm0, ymm1, ymm2 | |
| vpmovsxbd ymm3, [rax] | vaddps zmm1{k5}, zmm2, [rax]{sint8} |
| vcvtdq2ps ymm3, ymm3 | |
| vaddps ymm4, ymm2, ymm3 | |
| vblendvps ymm1, ymm5, | |
| ymm1, ymm4 | |
| vmaskmovps ymm1, ymm7, | vmovaps zmm1 {k7}, [rbx] |
| [rbx] vbroadcastss ymm0, [rax] | vaddps zmm2{k7}{z}, |
| vaddps ymm2, ymm0, ymm1 | zmm1, [rax]{1toN} |
| vblendvps ymm2, ymm2, | |
| ymm1, ymm7 | |

Where [rax] is the base pointer to be used for address generation, and where { } indicates a conversion operation specified by the data manipulation filed (described in more detail later here).

Scale field 960—its content allows for the scaling of the index field's content for memory address generation (e.g., for address generation that uses 2^{scale}*index+base).

Displacement Field 962A—its content is used as part of memory address generation (e.g., for address generation that uses 2^{scale}*index+base+displacement).

Displacement Factor Field 962B (note that the juxtaposition of displacement field 962A directly over displacement factor field 962B indicates one or the other is used)—its content is used as part of address generation; it specifies a displacement factor that is to be scaled by the size of a memory access (N)—where N is the number of bytes in the memory access (e.g., for address generation that uses 2^{scale}*index+base+scaled displacement). Redundant low-order bits are ignored and hence, the displacement factor field's content is multiplied by the memory operands total size (N) in order to generate the final displacement to be used in calculating an effective address. The value of N is determined by the processor hardware at runtime based on the full opcode field 974 (described later herein) and the data manipulation field 954C as described later herein. The displacement field 962A and the displacement factor field 962B are optional in the sense that they are not used for the no memory access 905 instruction templates and/or different embodiments may implement only one or none of the two.

Data element width field 964—its content distinguishes which one of a number of data element widths is to be used (in some embodiments for all instructions; in other embodiments for only some of the instructions). This field is optional in the sense that it is not needed if only one data element width is supported and/or data element widths are supported using some aspect of the opcodes.

Write mask field 970—its content controls, on a per data element position basis, whether that data element position in the destination vector operand reflects the result of the base operation and augmentation operation. Class A instruction templates support merging-writemasking, while class B instruction templates support both merging- and zeroing-writemasking. When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the write mask field 970 allows for partial vector operations, including loads, stores, arithmetic, logical, etc. Also, this masking can be used for fault suppression (i.e., by masking the destination's data element positions to prevent receipt of the result of any operation that may/will cause a fault—e.g., assume that a vector in memory crosses a page boundary and that the first page but not the second page would cause a page fault, the page fault can be ignored if all data element of the vector that lie on the first page are masked by the write mask). Further, write masks allow for “vectorizing loops” that contain certain types of conditional statements. While embodiments of the invention are described in which the write mask field's 970 content selects one of a number of write mask registers that contains the write mask to be used (and thus the write mask field's 970 content indirectly identifies that masking to be performed), alternative embodiments instead or additional allow the mask write field's 970 content to directly specify the masking to be performed. Further, zeroing allows for performance improvements when: 1) register renaming is used on instructions whose destination operand is not also a source (also call non-ternary instructions) because during the register renaming pipeline stage the destination is no longer an implicit source (no data elements from the current destination register need be copied to the renamed destination register or somehow carried along with the operation because any data element that is not the result of operation (any masked data element) will be zeroed); and 2) during the write back stage because zeros are being written.

Immediate field 972—its content allows for the specification of an immediate. This field is optional in the sense that is it not present in an implementation of the generic vector friendly format that does not support immediate and it is not present in instructions that do not use an immediate.

Instruction Template Class Selection

Class field 968—its content distinguishes between different classes of instructions. With reference to FIGS. 2A-B, the contents of this field select between class A and class B instructions. In FIGS. 9A-B, rounded corner squares are used to indicate a specific value is present in a field (e.g., class A 968A and class B 968B for the class field 968 respectively in FIGS. 9A-B).

No-Memory Access Instruction Templates of Class A

In the case of the non-memory access 905 instruction templates of class A, the alpha field 952 is interpreted as an RS field 952A, whose content distinguishes which one of the different augmentation operation types are to be performed (e.g., round 952A.1 and data transform 952A.2 are respectively specified for the no memory access, round type operation 910 and the no memory access, data transform type operation 915 instruction templates), while the beta field 954 distinguishes which of the operations of the specified type is to be performed. In FIG. 9, rounded corner blocks are used to indicate a specific value is present (e.g., no memory access 946A in the modifier field 946; round 952A.1 and data transform 952A.2 for alpha field 952/rs field 952A). In the no memory access 905 instruction templates, the scale field 960, the displacement field 962A, and the displacement scale filed 962B are not present.

### No-Memory Access Instruction Templates—Full Round Control Type Operation

In the no memory access full round control type operation 910 instruction template, the beta field 954 is interpreted as a round control field 954A, whose content(s) provide static rounding. While in the described embodiments of the invention the round control field 954A includes a suppress all floating point exceptions (SAE) field 956 and a round operation control field 958, alternative embodiments may support may encode both these concepts into the same field or only have one or the other of these concepts/fields (e.g., may have only the round operation control field 958).

SAE field 956—its content distinguishes whether or not to disable the exception event reporting; when the SAE field's 956 content indicates suppression is enabled, a given instruction does not report any kind of floating-point exception flag and does not raise any floating point exception handler.

Round operation control field 958—its content distinguishes which one of a group of rounding operations to perform (e.g., Round-up, Round-down, Round-towards-zero and Round-to-nearest). Thus, the round operation control field 958 allows for the changing of the rounding mode on a per instruction basis, and thus is particularly useful when this is required. In one embodiment of the invention where a processor includes a control register for specifying rounding modes, the round operation control field's 950 content overrides that register value (Being able to choose the rounding mode without having to perform a save-modify-restore on such a control register is advantageous).

### No Memory Access Instruction Templates—Data Transform Type Operation

In the no memory access data transform type operation 915 instruction template, the beta field 954 is interpreted as a data transform field 954B, whose content distinguishes which one of a number of data transforms is to be performed (e.g., no data transform, swizzle, broadcast).

Memory Access Instruction Templates of Class A

In the case of a memory access 920 instruction template of class A, the alpha field 952 is interpreted as an eviction hint field 952B, whose content distinguishes which one of the eviction hints is to be used (in FIG. 9A, temporal 952B.1 and non-temporal 952B.2 are respectively specified for the memory access, temporal 925 instruction template and the memory access, non-temporal 930 instruction template), while the beta field 954 is interpreted as a data manipulation field 954C, whose content distinguishes which one of a number of data manipulation operations (also known as primitives) is to be performed (e.g., no manipulation; broadcast; up conversion of a source; and down conversion of a destination). The memory access 920 instruction templates include the scale field 960, and optionally the displacement field 962A or the displacement scale field 962B.

Vector Memory Instructions perform vector loads from and vector stores to memory, with conversion support. As with regular vector instructions, vector memory instructions transfer data from/to memory in a data element-wise fashion, with the elements that are actually transferred dictated by the contents of the vector mask that is selected as the write mask. In FIG. 9A, rounded corner squares are used to indicate a specific value is present in a field (e.g., memory access 946B for the modifier field 946; temporal 952B.1 and non-temporal 952B.2 for the alpha field 952/eviction hint field 952B)

Memory Access Instruction Templates—Temporal

Temporal data is data likely to be reused soon enough to benefit from caching. This is, however, a hint, and different processors may implement it in different ways, including ignoring the hint entirely.

Memory Access Instruction Templates—Non-Temporal

Non-temporal data is data unlikely to be reused soon enough to benefit from caching in the 1st-level cache and should be given priority for eviction. This is, however, a hint, and different processors may implement it in different ways, including ignoring the hint entirely.

Instruction Templates of Class B

In the case of the instruction templates of class B, the alpha field 952 is interpreted as a write mask control (Z) field 952C, whose content distinguishes whether the write masking controlled by the write mask field 970 should be a merging or a zeroing.

No-Memory Access Instruction Templates of Class B

In the case of the non-memory access 905 instruction templates of class B, part of the beta field 954 is interpreted as an RL field 957A, whose content distinguishes which one of the different augmentation operation types are to be performed (e.g., round 957A.1 and vector length (VSIZE) 957A.2 are respectively specified for the no memory access, write mask control, partial round control type operation 912 instruction template and the no memory access, write mask control, VSIZE type operation 917 instruction template), while the rest of the beta field 954 distinguishes which of the operations of the specified type is to be performed. In FIG. 9, rounded corner blocks are used to indicate a specific value is present (e.g., no memory access 946A in the modifier field 946; round 957A.1 and VSIZE 957A.2 for the RL field 957A). In the no memory access 905 instruction templates, the scale field 960, the displacement field 962A, and the displacement scale filed 962B are not present.

No-Memory Access Instruction Templates—Write Mask Control, Partial Round Control Type Operation

In the no memory access, write mask control, partial round control type operation 910 instruction template, the rest of the beta field 954 is interpreted as a round operation field 959A and exception event reporting is disabled (a given instruction does not report any kind of floating-point exception flag and does not raise any floating point exception handler).

Round operation control field 959A—just as round operation control field 958, its content distinguishes which one of a group of rounding operations to perform (e.g., Round-up, Round-down, Round-towards-zero and Round-to-nearest). Thus, the round operation control field 959A allows for the changing of the rounding mode on a per instruction basis, and thus is particularly useful when this is required. In one embodiment of the invention where a processor includes a control register for specifying rounding modes, the round operation control field's 950 content overrides that register value (Being able to choose the rounding mode without having to perform a save-modify-restore on such a control register is advantageous).

No Memory Access Instruction Templates—Write Mask Control, VSIZE Type Operation

In the no memory access, write mask control, VSIZE type operation 917 instruction template, the rest of the beta field 954 is interpreted as a vector length field 959B, whose content distinguishes which one of a number of data vector length is to be performed on (e.g., 128, 956, or 1112 byte).

Memory Access Instruction Templates of Class B

In the case of a memory access 920 instruction template of class A, part of the beta field 954 is interpreted as a broadcast field 957B, whose content distinguishes whether or not the broadcast type data manipulation operation is to be performed, while the rest of the beta field 954 is interpreted the vector length field 959B. The memory access 920 instruction templates include the scale field 960, and optionally the displacement field 962A or the displacement scale field 962B.

Additional Comments Regarding Fields

With regard to the generic vector friendly instruction format 900, a full opcode field 974 is shown including the format field 940, the base operation field 942, and the data element width field 964. While one embodiment is shown where the full opcode field 974 includes all of these fields, the full opcode field 974 includes less than all of these fields in embodiments that do not support all of them. The full opcode field 974 provides the operation code.

The augmentation operation field 950, the data element width field 964, and the write mask field 970 allow these features to be specified on a per instruction basis in the generic vector friendly instruction format.

The combination of write mask field and data element width field create typed instructions in that they allow the mask to be applied based on different data element widths.

The instruction format requires a relatively small number of bits because it reuses different fields for different purposes based on the contents of other fields. For instance, one perspective is that the modifier field's content choses between the no memory access 905 instructions templates on FIGS. 9A-B and the memory access 9250 instruction templates on FIGS. 9A-B; while the class field 968's content choses within those non-memory access 905 instruction templates between instruction templates 910/915 of FIG. 9A and 912/917 of FIG. 9B; and while the class field 968's content choses within those memory access 920 instruction templates between instruction templates 925/930 of FIGS. 9A and 927 of FIG. 9B. From another perspective, the class field 968's content choses between the class A and class B instruction templates respectively of FIGS. 9A and B; while the modifier field's content choses within those class A instruction templates between instruction templates 905 and 920 of FIG. 9A; and while the modifier field's content choses within those class B instruction templates between instruction templates 905 and 920 of FIG. 9B. In the case of the class field's content indicating a class A instruction template, the content of the modifier field 946 choses the interpretation of the alpha field 952 (between the rs field 952A and the EH field 952B. In a related manner, the contents of the modifier field 946 and the class field 968 chose whether the alpha field is interpreted as the rs field 952A, the EH field 952B, or the write mask control (Z) field 952C. In the case of the class and modifier fields indicating a class A no memory access operation, the interpretation of the augmentation field's beta field changes based on the rs field's content; while in the case of the class and modifier fields indicating a class B no memory access operation, the interpretation of the beta field depends on the contents of the RL field. In the case of the class and modifier fields indicating a class A memory access operation, the interpretation of the augmentation field's beta field changes based on the base operation field's content; while in the case of the class and modifier fields indicating a class B memory access operation, the interpretation of the augmentation field's beta field's broadcast field 957B changes based on the base operation field's contents. Thus, the combination of the base operation field, modifier field and the augmentation operation field allow for an even wider variety of augmentation operations to be specified.

The various instruction templates found within class A and class B are beneficial in different situations. Class A is useful when zeroing-writemasking or smaller vector lengths are desired for performance reasons. For example, zeroing allows avoiding fake dependences when renaming is used since we no longer need to artificially merge with the destination; as another example, vector length control eases store-load forwarding issues when emulating shorter vector sizes with the vector mask. Class B is useful when it is desirable to: 1) allow floating point exceptions (i.e., when the contents of the SAE field indicate no) while using rounding-mode controls at the same time; 2) be able to use upconversion, swizzling, swap, and/or downconversion; 3) operate on the graphics data type. For instance, upconversion, swizzling, swap, downconversion, and the graphics data type reduce the number of instructions required when working with sources in a different format; as another example, the ability to allow exceptions provides full IEEE compliance with directed rounding-modes.

Exemplary Specific Vector Friendly Instruction Format

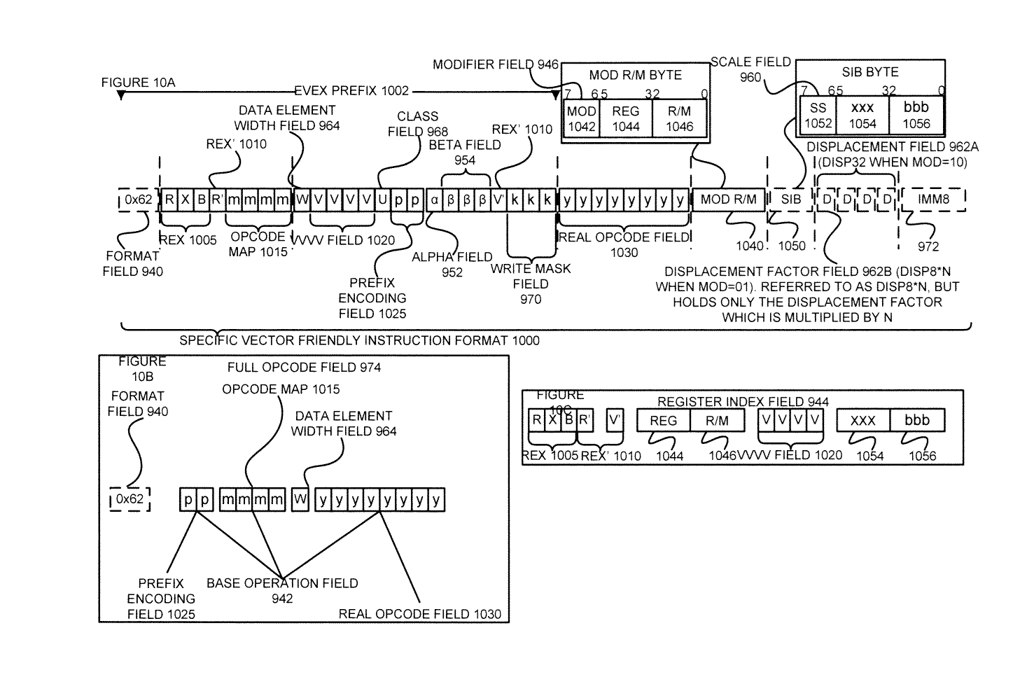

FIG. 10 is a block diagram illustrating an exemplary specific vector friendly instruction format according to embodiments of the invention. FIG. 10 shows a specific vector friendly instruction format 1000 that is specific in the sense that it specifies the location, size, interpretation, and order of the fields, as well as values for some of those fields. The specific vector friendly instruction format 1000 may be used to extend the x86 instruction set, and thus some of the fields are similar or the same as those used in the existing x86 instruction set and extension thereof (e.g., AVX). This format remains consistent with the prefix encoding field, real opcode byte field, MOD R/M field, SIB field, displacement field, and immediate fields of the existing x86 instruction set with extensions. The fields from FIG. 9 into which the fields from FIG. 10 map are illustrated.

It should be understand that although embodiments of the invention are described with reference to the specific vector friendly instruction format 1000 in the context of the generic vector friendly instruction format 900 for illustrative purposes, the invention is not limited to the specific vector friendly instruction format 1000 except where claimed. For example, the generic vector friendly instruction format 900 contemplates a variety of possible sizes for the various fields, while the specific vector friendly instruction format 1000 is shown as having fields of specific sizes. By way of specific example, while the data element width field 964 is illustrated as a one bit field in the specific vector friendly instruction format 1000, the invention is not so limited (that is, the generic vector friendly instruction format 900 contemplates other sizes of the data element width field 964).

Format—FIG. 10

The generic vector friendly instruction format 900 includes the following fields listed below in the order illustrated in FIG. 10.

EVEX Prefix (Bytes 0-3)

EVEX Prefix 1002—is encoded in a four-byte form.

Format Field 940 (EVEX Byte 0, bits [7:0])—the first byte (EVEX Byte 0) is the format field 940 and it contains 0x62 (the unique value used for distinguishing the vector friendly instruction format in one embodiment of the invention).

The second-fourth bytes (EVEX Bytes 1-3) include a number of bit fields providing specific capability.

REX field 1005 (EVEX Byte 1, bits [7-5])—consists of a EVEX.R bit field (EVEX Byte 1, bit [7]—R), EVEX.X bit field (EVEX byte 1, bit [6] —X), and 957BEX byte 1, bit[5] —B). The EVEX.R, EVEX.X, and EVEX.B bit fields provide the same functionality as the corresponding VEX bit fields, and are encoded using 1s complement form, i.e. ZMM0 is encoded as 1111B, ZMM15 is encoded as 0000B. Other fields of the instructions encode the lower three bits of the register indexes as is known in the art (rrr, xxx, and bbb), so that Rrrr, Xxxx, and Bbbb may be formed by adding EVEX.R, EVEX.X, and EVEX.B.

REX′ field 1010—this is the first part of the REX′ field 1010 and is the EVEX.R′ bit field (EVEX Byte 1, bit [4]—R′) that is used to encode either the upper 16 or lower 16 of the extended 32 register set. In one embodiment of the invention, this bit, along with others as indicated below, is stored in bit inverted format to distinguish (in the well-known x86 32-bit mode) from the BOUND instruction, whose real opcode byte is 62, but does not accept in the MOD R/M field (described below) the value of 11 in the MOD field; alternative embodiments of the invention do not store this and the other indicated bits below in the inverted format. A value of 1 is used to encode the lower 16 registers. In other words, R′Rrrr is formed by combining EVEX.R′, EVEX.R, and the other RRR from other fields.

Opcode map field 1015 (EVEX byte 1, bits [3:0]—mmmm)—its content encodes an implied leading opcode byte (0F, 0F 38, or 0F 3).

Data element width field 964 (EVEX byte 2, bit [7]—W)—is represented by the notation EVEX.W. EVEX.W is used to define the granularity (size) of the datatype (either 32-bit data elements or 64-bit data elements).

EVEX.vvvv 1020 (EVEX Byte 2, bits [6:3]—vvvv)—the role of EVEX.vvvv may include the following: 1) EVEX.vvvv encodes the first source register operand, specified in inverted (1s complement) form and is valid for instructions with 2 or more source operands; 2) EVEX.vvvv encodes the destination register operand, specified in 1s complement form for certain vector shifts; or 3) EVEX.vvvv does not encode any operand, the field is reserved and should contain 1111b. Thus, EVEX.vvvv field 1020 encodes the 4 low-order bits of the first source register specifier stored in inverted (1s complement) form. Depending on the instruction, an extra different EVEX bit field is used to extend the specifier size to 32 registers.

EVEX.0 968 Class field (EVEX byte 2, bit [2]—U)—If EVEX.0=0, it indicates class A or EVEX.U0; if EVEX.0=1, it indicates class B or EVEX.U1.

Prefix encoding field 1025 (EVEX byte 2, bits [1:0]—pp)—provides additional bits for the base operation field. In addition to providing support for the legacy SSE instructions in the EVEX prefix format, this also has the benefit of compacting the SIMD prefix (rather than requiring a byte to express the SIMD prefix, the EVEX prefix requires only 2 bits). In one embodiment, to support legacy SSE instructions that use a SIMD prefix (66H, F2H, F3H) in both the legacy format and in the EVEX prefix format, these legacy SIMD prefixes are encoded into the SIMD prefix encoding field; and at runtime are expanded into the legacy SIMD prefix prior to being provided to the decoder's PLA (so the PLA can execute both the legacy and EVEX format of these legacy instructions without modification). Although newer instructions could use the EVEX prefix encoding field's content directly as an opcode extension, certain embodiments expand in a similar fashion for consistency but allow for different meanings to be specified by these legacy SIMD prefixes. An alternative embodiment may redesign the PLA to support the 2 bit SIMD prefix encodings, and thus not require the expansion.

Alpha field 952 (EVEX byte 3, bit [7]—EH; also known as EVEX.EH, EVEX.rs, EVEX.RL, EVEX.write mask control, and EVEX.N; also illustrated with α)—as previously described, this field is context specific. Additional description is provided later herein.

Beta field 954 (EVEX byte 3, bits [6:4]—SSS, also known as EVEX.s₂₋₀, EVEX.r₂₋₀, EVEX.rr1, EVEX.LL0, EVEX.LLB; also illustrated with βββ)—as previously described, this field is context specific. Additional description is provided later herein.

REX′ field 1010—this is the remainder of the REX′ field and is the EVEX.V′ bit field (EVEX Byte 3, bit [3]—V′) that may be used to encode either the upper 16 or lower 16 of the extended 32 register set. This bit is stored in bit inverted format. A value of 1 is used to encode the lower 16 registers. In other words, V′VVVV is formed by combining EVEX.V′, EVEX.vvvv.

Write mask field 970 (EVEX byte 3, bits [2:0]—kkk)—its content specifies the index of a register in the write mask registers as previously described. In one embodiment of the invention, the specific value EVEX.kkk=000 has a special behavior implying no write mask is used for the particular instruction (this may be implemented in a variety of ways including the use of a write mask hardwired to all ones or hardware that bypasses the masking hardware).

Real Opcode Field 1030 (Byte 4)

This is also known as the opcode byte. Part of the opcode is specified in this field.

MOD R/M Field 1040 (Byte 5)

Modifier field 946 (MODR/M.MOD, bits [7-6]—MOD field 1042)—As previously described, the MOD field's 1042 content distinguishes between memory access and non-memory access operations. This field will be further described later herein.

MODR/M.reg field 1044, bits [5-3]—the role of ModR/M.reg field can be summarized to two situations: ModR/M.reg encodes either the destination register operand or a source register operand, or ModR/M.reg is treated as an opcode extension and not used to encode any instruction operand.

MODR/M.r/m field 1046, bits [2-0]—The role of ModR/M.r/m field may include the following: ModR/M.r/m encodes the instruction operand that references a memory address, or ModR/M.r/m encodes either the destination register operand or a source register operand.

Scale, Index, Base (SIB) Byte (Byte 6)

Scale field 960 (SIB.SS, bits [7-6]—As previously described, the scale field's 960 content is used for memory address generation. This field will be further described later herein.

SIB.xxx 1054 (bits [5-3] and SIB.bbb 1056 (bits [2-0])—the contents of these fields have been previously referred to with regard to the register indexes Xxxx and Bbbb. Displacement Byte(s) (Byte 7 or Bytes 7-10)

Displacement field 962A (Bytes 7-10)—when MOD field 1042 contains 10, bytes 7-10 are the displacement field 962A, and it works the same as the legacy 32-bit displacement (disp32) and works at byte granularity.

Displacement factor field 962B (Byte 7)—when MOD field 1042 contains 01, byte 7 is the displacement factor field 962B. The location of this field is that same as that of the legacy x86 instruction set 8-bit displacement (disp8), which works at byte granularity. Since disp8 is sign extended, it can only address between −128 and 127 bytes offsets; in terms of 64 byte cache lines, disp8 uses 8 bits that can be set to only four really useful values −128, −64, 0, and 64; since a greater range is often needed, disp32 is used; however, disp32 requires 4 bytes. In contrast to disp8 and disp32, the displacement factor field 962B is a reinterpretation of disp8; when using displacement factor field 962B, the actual displacement is determined by the content of the displacement factor field multiplied by the size of the memory operand access (N). This type of displacement is referred to as disp8*N. This reduces the average instruction length (a single byte of used for the displacement but with a much greater range). Such compressed displacement is based on the assumption that the effective displacement is multiple of the granularity of the memory access, and hence, the redundant low-order bits of the address offset do not need to be encoded. In other words, the displacement factor field 962B substitutes the legacy x86 instruction set 8-bit displacement. Thus, the displacement factor field 962B is encoded the same way as an x86 instruction set 8-bit displacement (so no changes in the ModRM/SIB encoding rules) with the only exception that disp8 is overloaded to disp8*N. In other words, there are no changes in the encoding rules or encoding lengths but only in the interpretation of the displacement value by hardware (which needs to scale the displacement by the size of the memory operand to obtain a byte-wise address offset).

Immediate

Immediate field 972 operates as previously described.

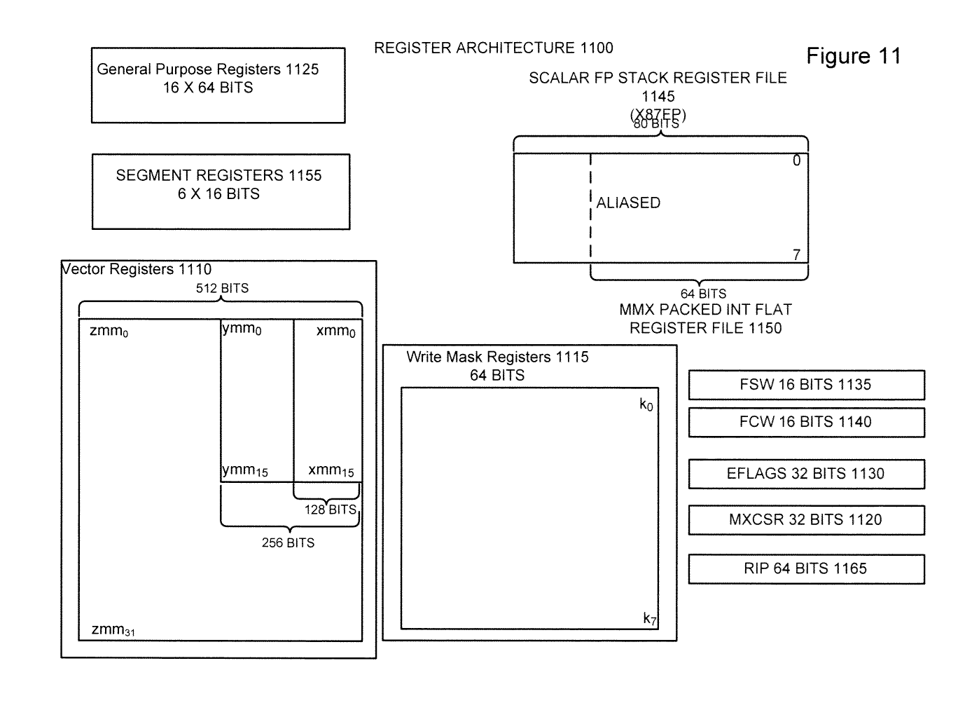

Exemplary Register Architecture—FIG. 11

FIG. 11 is a block diagram of a register architecture 1100 according to one embodiment of the invention. The register files and registers of the register architecture are listed below:

Vector register file 1110—in the embodiment illustrated, there are 32 vector registers that are 1112 bits wide; these registers are referenced as zmm0 through zmm31. The lower order 956 bits of the lower 16 zmm registers are overlaid on registers ymm0-16. The lower order 128 bits of the lower 16 zmm registers (the lower order 128 bits of the ymm registers) are overlaid on registers xmm0-15. The specific vector friendly instruction format 1000 operates on these overlaid register file as illustrated in the below tables.

| Adjustable | | | |
|---|---|---|---|
| Vector Length | Class | Operations | Registers |
| Instruction | A (FIG. 9A; | 910, 915, 925, | zmm registers |
| Templates that | U = 0) | 930 | (the vector |
| do not include | | | length is 64 byte) |
| the vector length | B (FIG. 9B; | 912 | zmm registers |
| field 959B | U = 1) | | (the vector |
| | | | length is 64 byte) |
| Instruction | B (FIG. 9B; | 917, 927 | zmm, ymm, or |
| Templates that | U = 1) | | xmm registers |
| do include the | | | (the vector |
| vector length | | | length is 64 byte, |
| field 959B | | | 32 byte, or 16 |
| | | | byte) depending |
| | | | on the vector |
| | | | length field 959B |

In other words, the vector length field 959B selects between a maximum length and one or more other shorter lengths, where each such shorter length is half the length of the preceding length; and instructions templates without the vector length field 959B operate on the maximum vector length. Further, in one embodiment, the class B instruction templates of the specific vector friendly instruction format 1000 operate on packed or scalar single/double-precision floating point data and packed or scalar integer data. Scalar operations are operations performed on the lowest order data element position in an zmm/ymm/xmm register; the higher order data element positions are either left the same as they were prior to the instruction or zeroed depending on the embodiment.

Write mask registers 1115—in the embodiment illustrated, there are 8 write mask registers (k0 through k7), each 64 bits in size. As previously described, in one embodiment of the invention the vector mask register k0 cannot be used as a write mask; when the encoding that would normally indicate k0 is used for a write mask, it selects a hardwired write mask of 0xFFFF, effectively disabling write masking for that instruction.

Multimedia Extensions Control Status Register (MXCSR) 1120—in the embodiment illustrated, this 32-bit register provides status and control bits used in floating-point operations.

General-purpose registers 1125—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Extended flags (EFLAGS) register 1130—in the embodiment illustrated, this 32 bit register is used to record the results of many instructions.

Floating Point Control Word (FCW) register 1135 and Floating Point Status Word (FSW) register 1140—in the embodiment illustrated, these registers are used by x87 instruction set extensions to set rounding modes, exception masks and flags in the case of the FCW, and to keep track of exceptions in the case of the FSW.

Scalar floating point stack register file (x87 stack) 1145 on which is aliased the MMX packed integer flat register file 1150—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Segment registers 1155—in the illustrated embodiment, there are six 16 bit registers use to store data used for segmented address generation.

RIP register 1165—in the illustrated embodiment, this 64 bit register that stores the instruction pointer.

Alternative embodiments of the invention may use wider or narrower registers. Additionally, alternative embodiments of the invention may use more, less, or different register files and registers.

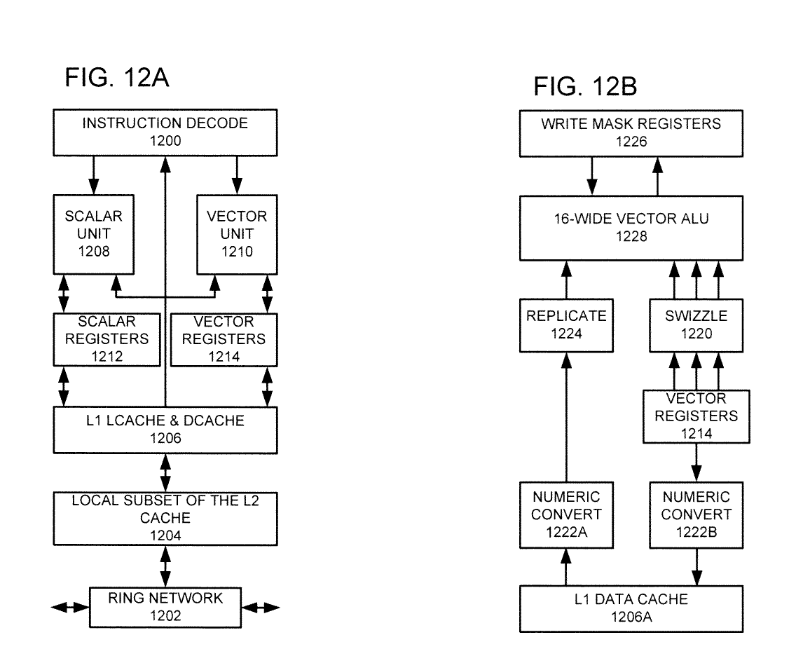

Exemplary in-Order Processor Architecture—FIGS. 12A-12b

FIGS. 12A-B illustrate a block diagram of an exemplary in-order processor architecture. These exemplary embodiments are designed around multiple instantiations of an in-order CPU core that is augmented with a wide vector processor (VPU). Cores communicate through a high-bandwidth interconnect network with some fixed function logic, memory I/O interfaces, and other necessary I/O logic, depending on the e14t application. For example, an implementation of this embodiment as a stand-alone GPU would typically include a PCIe bus.

FIG. 12A is a block diagram of a single CPU core, along with its connection to the on-die interconnect network 1202 and with its local subset of the level 2 (L2) cache 1204, according to embodiments of the invention. An instruction decoder 1200 supports the x86 instruction set with an extension including the specific vector instruction format 1000. While in one embodiment of the invention (to simplify the design) a scalar unit 1208 and a vector unit 1210 use separate register sets (respectively, scalar registers 1212 and vector registers 1214) and data transferred between them is written to memory and then read back in from a level 1 (L1) cache 1206, alternative embodiments of the invention may use a different approach (e.g., use a single register set or include a communication path that allow data to be transferred between the two register files without being written and read back).

The L1 cache 1206 allows low-latency accesses to cache memory into the scalar and vector units. Together with load-op instructions in the vector friendly instruction format, this means that the L1 cache 1206 can be treated somewhat like an extended register file. This significantly improves the performance of many algorithms, especially with the eviction hint field 952B.

The local subset of the L2 cache 1204 is part of a global L2 cache that is divided into separate local subsets, one per CPU core. Each CPU has a direct access path to its own local subset of the L2 cache 1204. Data read by a CPU core is stored in its L2 cache subset 1204 and can be accessed quickly, in parallel with other CPUs accessing their own local L2 cache subsets. Data written by a CPU core is stored in its own L2 cache subset 1204 and is flushed from other subsets, if necessary. The ring network ensures coherency for shared data.

FIG. 12B is an exploded view of part of the CPU core in FIG. 12A according to embodiments of the invention. FIG. 12B includes an L1 data cache 1206A part of the L1 cache 1204, as well as more detail regarding the vector unit 1210 and the vector registers 1214. Specifically, the vector unit 1210 is a 16-wide vector processing unit (VPU) (see the 16-wide ALU 1228), which executes integer, single-precision float, and double-precision float instructions. The VPU supports swizzling the register inputs with swizzle unit 1220, numeric conversion with numeric convert units 1222A-B, and replication with replication unit 1224 on the memory input. Write mask registers 1226 allow predicating the resulting vector writes.

Register data can be swizzled in a variety of ways, e.g. to support matrix multiplication. Data from memory can be replicated across the VPU lanes. This is a common operation in both graphics and non-graphics parallel data processing, which significantly increases the cache efficiency.

The ring network is bi-directional to allow agents such as CPU cores, L2 caches and other logic blocks to communicate with each other within the chip. Each ring data-path is 1112-bits wide per direction.

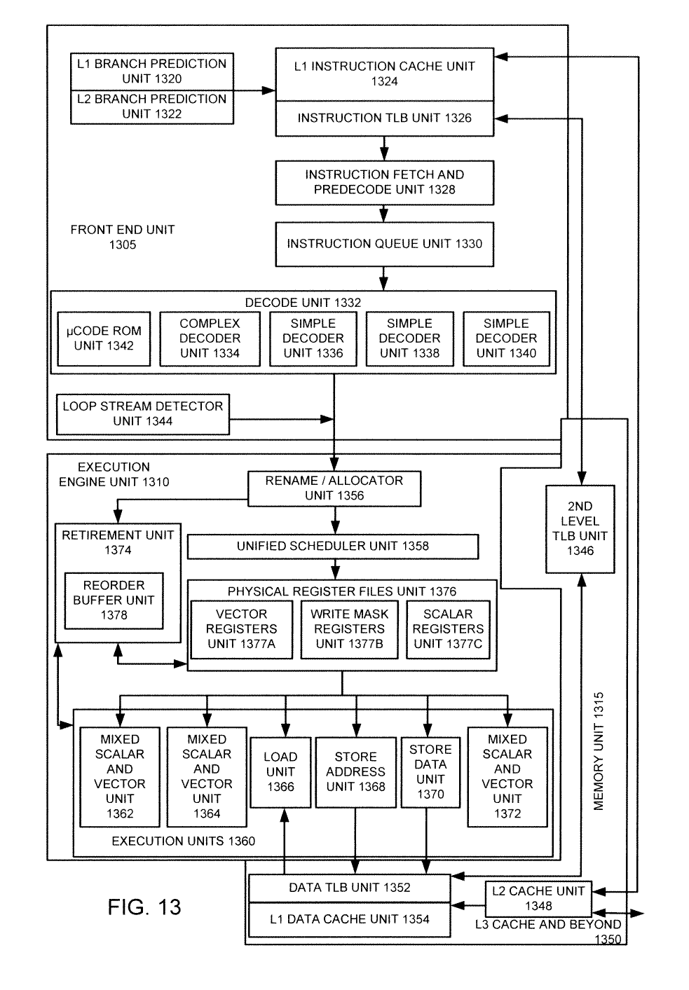

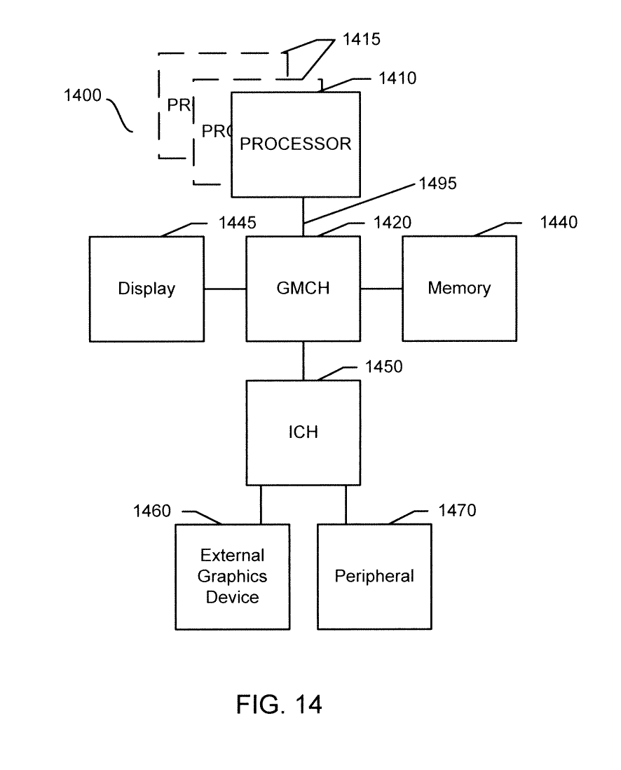

Exemplary Out-of-Order Architecture—FIG. 13

FIG. 13 is a block diagram illustrating an exemplary out-of-order architecture according to embodiments of the invention. Specifically, FIG. 13 illustrates a well-known exemplary out-of-order architecture that has been modified to incorporate the vector friendly instruction format and execution thereof. In FIG. 13 arrows denotes a coupling between two or more units and the direction of the arrow indicates a direction of data flow between those units. FIG. 13 includes a front end unit 1305 coupled to an execution engine unit 1310 and a memory unit 1315; the execution engine unit 1310 is further coupled to the memory unit 1315.

The front end unit 1305 includes a level 1 (L1) branch prediction unit 1320 coupled to a level 2 (L2) branch prediction unit 1322. The L1 and L2 brand prediction units 1320 and 1322 are coupled to an L1 instruction cache unit 1324. The L1 instruction cache unit 1324 is coupled to an instruction translation lookaside buffer (TLB) 1326 which is further coupled to an instruction fetch and predecode unit 1328. The instruction fetch and predecode unit 1328 is coupled to an instruction queue unit 1330 which is further coupled a decode unit 1332. The decode unit 1332 comprises a complex decoder unit 1334 and three simple decoder units 1336, 1338, and 1340. The decode unit 1332 includes a micro-code ROM unit 1342. The decode unit 1332 may operate as previously described above in the decode stage section. The L1 instruction cache unit 1324 is further coupled to an L2 cache unit 1348 in the memory unit 1315. The instruction TLB unit 1326 is further coupled to a second level TLB unit 1346 in the memory unit 1315. The decode unit 1332, the micro-code ROM unit 1342, and a loop stream detector unit 1344 are each coupled to a rename/allocator unit 1356 in the execution engine unit 1310.

The execution engine unit 1310 includes the rename/allocator unit 1356 that is coupled to a retirement unit 1374 and a unified scheduler unit 1358. The retirement unit 1374 is further coupled to execution units 1360 and includes a reorder buffer unit 1378. The unified scheduler unit 1358 is further coupled to a physical register files unit 1376 which is coupled to the execution units 1360. The physical register files unit 1376 comprises a vector registers unit 1377A, a write mask registers unit 1377B, and a scalar registers unit 1377C; these register units may provide the vector registers 1110, the vector mask registers 1115, and the general purpose registers 1125; and the physical register files unit 1376 may include additional register files not shown (e.g., the scalar floating point stack register file 1145 aliased on the MMX packed integer flat register file 1150). The execution units 1360 include three mixed scalar and vector units 1362, 1364, and 1372; a load unit 1366; a store address unit 1368; a store data unit 1370. The load unit 1366, the store address unit 1368, and the store data unit 1370 are each coupled further to a data TLB unit 1352 in the memory unit 1315.

The memory unit 1315 includes the second level TLB unit 1346 which is coupled to the data TLB unit 1352. The data TLB unit 1352 is coupled to an L1 data cache unit 1354. The L1 data cache unit 1354 is further coupled to an L2 cache unit 1348. In some embodiments, the L2 cache unit 1348 is further coupled to L3 and higher cache units 1350 inside and/or outside of the memory unit 1315.

By way of example, the exemplary out-of-order architecture may implement a process pipeline as follows: 1) the instruction fetch and predecode unit 1328 perform the fetch and length decoding stages; 2) the decode unit 1332 performs the decode stage; 3) the rename/allocator unit 1356 performs the allocation stage and renaming stage; 4) the unified scheduler 1358 performs the schedule stage; 5) the physical register files unit 1376, the reorder buffer unit 1378, and the memory unit 1315 perform the register read/memory read stage; the execution units 1360 perform the execute/data transform stage; 6) the memory unit 1315 and the reorder buffer unit 1378 perform the write back/memory write stage; 7) the retirement unit 1374 performs the ROB read stage; 8) various units may be involved in the exception handling stage 9164; and 9) the retirement unit 1374 and the physical register files unit 1376 perform the commit stage.

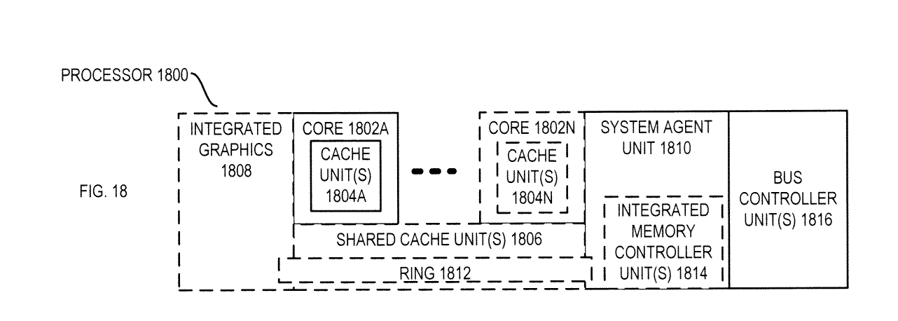

Exemplary Single Core and Multicore Processors—FIG. 18

FIG. 18 is a block diagram of a single core processor and a multicore processor 1800 with integrated memory controller and graphics according to embodiments of the invention. The solid lined boxes in FIG. 18 illustrate a processor 1800 with a single core 1802A, a system agent 1810, a set of one or more bus controller units 1816, while the optional addition of the dashed lined boxes illustrates an alternative processor 1800 with multiple cores 1802A-N, a set of one or more integrated memory controller unit(s) 1814 in the system agent unit 1810, and an integrated graphics logic 1808.

The memory hierarchy includes one or more levels of cache within the cores, a set or one or more shared cache units 1806, and external memory (not shown) coupled to the set of integrated memory controller units 1814. The set of shared cache units 1806 may include one or more mid-level caches, such as level 2 (L2), level 3 (L3), level 4 (L4), or other levels of cache, a last level cache (LLC), and/or combinations thereof. While in one embodiment a ring based interconnect unit 1812 interconnects the integrated graphics logic 1808, the set of shared cache units 1806, and the system agent unit 1810, alternative embodiments may use any number of well-known techniques for interconnecting such units.

In some embodiments, one or more of the cores 1802A-N are capable of multi-threading. The system agent 1810 includes those components coordinating and operating cores 1802A-N. The system agent unit 1810 may include for example a power control unit (PCU) and a display unit. The PCU may be or include logic and components needed for regulating the power state of the cores 1802A-N and the integrated graphics logic 1808. The display unit is for driving one or more externally connected displays.

The cores 1802A-N may be homogenous or heterogeneous in terms of architecture and/or instruction set. For example, some of the cores 1802A-N may be in order (e.g., like that shown in FIGS. 12A and 12B) while others are out-of-order (e.g., like that shown in FIG. 13). As another example, two or more of the cores 1802A-N may be capable of executing the same instruction set, while others may be capable of executing only a subset of that instruction set or a different instruction set. At least one of the cores is capable of executing the vector friendly instruction format described herein.

The processor may be a general-purpose processor, such as a Core™ i3, i5, i7, 2 Duo and Quad, Xeon™, or Itanium™ processor, which are available from Intel Corporation, of Santa Clara, Calif. Alternatively, the processor may be from another company. The processor may be a special-purpose processor, such as, for example, a network or communication processor, compression engine, graphics processor, co-processor, embedded processor, or the like. The processor may be implemented on one or more chips. The processor 1800 may be a part of and/or may be implemented on one or more substrates using any of a number of process technologies, such as, for example, BiCMOS, CMOS, or NMOS.

Exemplary Computer Systems and Processors—FIGS. 14-17

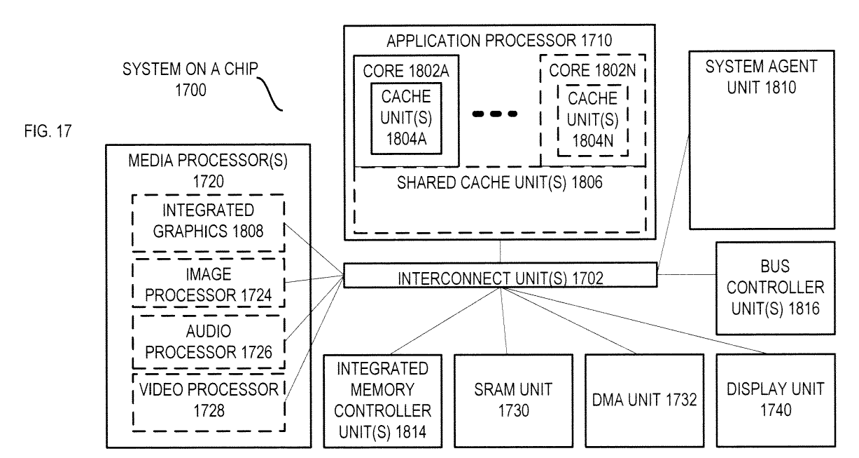

FIGS. 14-16 are exemplary systems suitable for including the processor 1800, while FIG. 17 is an exemplary system on a chip (SoC) that may include one or more of the cores 1802. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 14, shown is a block diagram of a system 1400 in accordance with one embodiment of the invention. The system 1400 may include one or more processors 1410, 1415, which are coupled to graphics memory controller hub (GMCH) 1420. The optional nature of additional processors 1415 is denoted in FIG. 14 with broken lines.

Each processor 1410, 1415 may be some version of processor 1800. However, it should be noted that it is unlikely that integrated graphics logic and integrated memory control units would exist in the processors 1410, 1415.

FIG. 14 illustrates that the GMCH 1420 may be coupled to a memory 1440 that may be, for example, a dynamic random access memory (DRAM). The DRAM may, for at least one embodiment, be associated with a non-volatile cache.

The GMCH 1420 may be a chipset, or a portion of a chipset. The GMCH 1420 may communicate with the processor(s) 1410, 1415 and control interaction between the processor(s) 1410, 1415 and memory 1440. The GMCH 1420 may also act as an accelerated bus interface between the processor(s) 1410, 1415 and other elements of the system 1400. For at least one embodiment, the GMCH 1420 communicates with the processor(s) 1410, 1415 via a multi-drop bus, such as a frontside bus (FSB) 1495.

Furthermore, GMCH 1420 is coupled to a display 1445 (such as a flat panel display). GMCH 1420 may include an integrated graphics accelerator. GMCH 1420 is further coupled to an input/output (I/O) controller hub (ICH) 1450, which may be used to couple various peripheral devices to system 1400. Shown for example in the embodiment of FIG. 14 is an external graphics device 1460, which may be a discrete graphics device coupled to ICH 1450, along with another peripheral device 1470.

Alternatively, additional or different processors may also be present in the system 1400. For example, additional processor(s) 1415 may include additional processors(s) that are the same as processor 1410, additional processor(s) that are heterogeneous or asymmetric to processor 1410, accelerators (such as, e.g., graphics accelerators or digital signal processing (DSP) units), field programmable gate arrays, or any other processor. There can be a variety of differences between the physical resources 1410, 1415 in terms of a spectrum of metrics of merit including architectural, microarchitectural, thermal, power consumption characteristics, and the like. These differences may effectively manifest themselves as asymmetry and heterogeneity amongst the processing elements 1410, 1415. For at least one embodiment, the various processing elements 1410, 1415 may reside in the same die package.

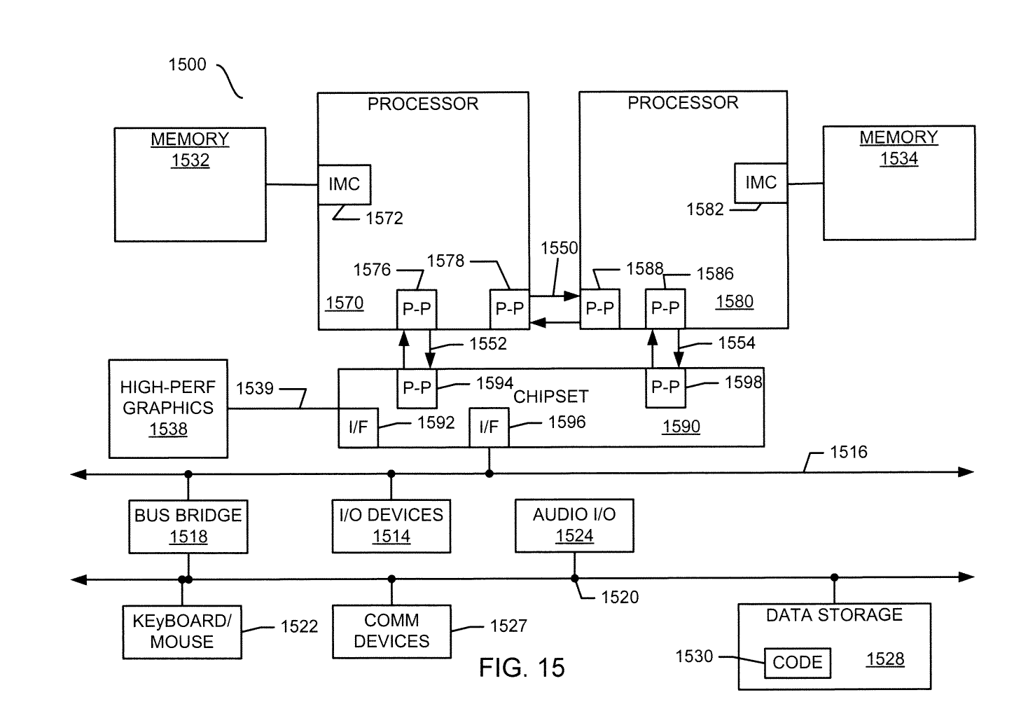

Referring now to FIG. 15, shown is a block diagram of a second system 1500 in accordance with an embodiment of the present invention. As shown in FIG. 15, multiprocessor system 1500 is a point-to-point interconnect system, and includes a first processor 1570 and a second processor 1580 coupled via a point-to-point interconnect 1550. As shown in FIG. 15, each of processors 1570 and 1580 may be some version of the processor 1800.

Alternatively, one or more of processors 1570, 1580 may be an element other than a processor, such as an accelerator or a field programmable gate array.

While shown with only two processors 1570, 1580, it is to be understood that the scope of the present invention is not so limited. In other embodiments, one or more additional processing elements may be present in a given processor.

Processor 1570 may further include an integrated memory controller hub (IMC) 1572 and point-to-point (P-P) interfaces 1576 and 1578. Similarly, second processor 1580 may include a IMC 1582 and P-P interfaces 1586 and 1588. Processors 1570, 1580 may exchange data via a point-to-point (PtP) interface 1550 using PtP interface circuits 1578, 1588. As shown in FIG. 15, IMC's 1572 and 1582 couple the processors to respective memories, namely a memory 1542 and a memory 1544, which may be portions of main memory locally attached to the respective processors.

Processors 1570, 1580 may each exchange data with a chipset 1590 via individual P-P interfaces 1552, 1554 using point to point interface circuits 1576, 1594, 1586, 1598. Chipset 1590 may also exchange data with a high-performance graphics circuit 1538 via a high-performance graphics interface 1539.

A shared cache (not shown) may be included in either processor outside of both processors, yet connected with the processors via P-P interconnect, such that either or both processors' local cache information may be stored in the shared cache if a processor is placed into a low power mode.

Chipset 1590 may be coupled to a first bus 1516 via an interface 1596. In one embodiment, first bus 1516 may be a Peripheral Component Interconnect (PCI) bus, or a bus such as a PCI Express bus or another third generation I/O interconnect bus, although the scope of the present invention is not so limited.

As shown in FIG. 15, various I/O devices 1514 may be coupled to first bus 1516, along with a bus bridge 1518 which couples first bus 1516 to a second bus 1520. In one embodiment, second bus 1520 may be a low pin count (LPC) bus. Various devices may be coupled to second bus 1520 including, for example, a keyboard/mouse 1522, communication devices 1526 and a data storage unit 1528 such as a disk drive or other mass storage device which may include code 1530, in one embodiment. Further, an audio I/O 1524 may be coupled to second bus 1520. Note that other architectures are possible. For example, instead of the point-to-point architecture of FIG. 15, a system may implement a multi-drop bus or other such architecture.

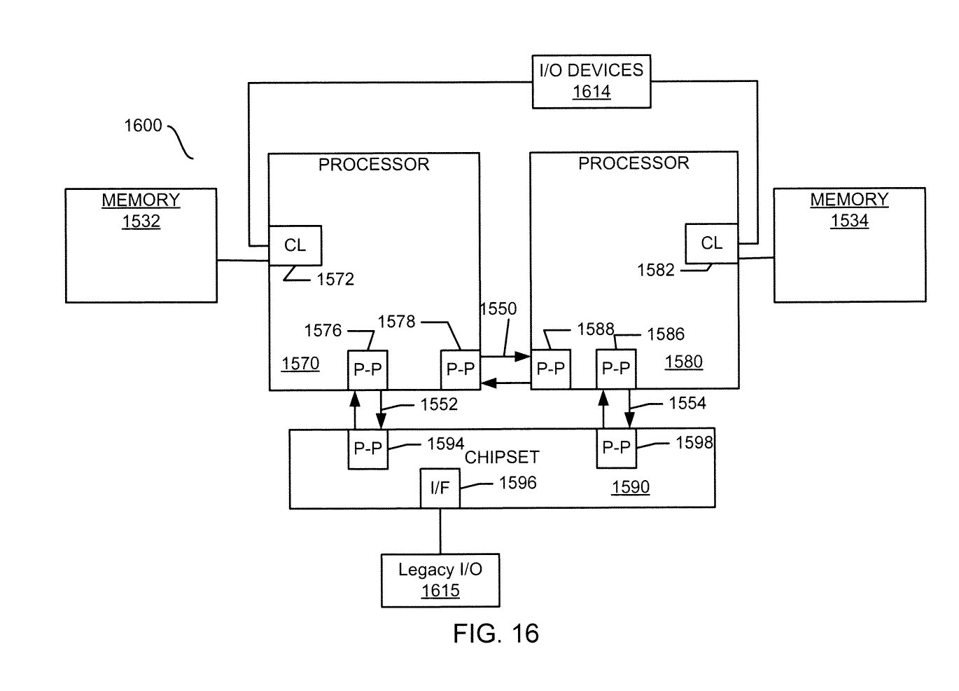

Referring now to FIG. 16, shown is a block diagram of a third system 1600 in accordance with an embodiment of the present invention. Like elements in FIGS. 15 and 16 bear like reference numerals, and certain aspects of FIG. 15 have been omitted from FIG. 16 in order to avoid obscuring other aspects of FIG. 16.

FIG. 16 illustrates that the processing elements 1570, 1580 may include integrated memory and I/O control logic (“CL”) 1572 and 1582, respectively. For at least one embodiment, the CL 1572, 1582 may include memory controller hub logic (IMC) such as that described above in connection with FIGS. 99 and 15. In addition. CL 1572, 1582 may also include I/O control logic. FIG. 16 illustrates that not only are the memories 1542, 1544 coupled to the CL 1572, 1582, but also that I/O devices 1614 are also coupled to the control logic 1572, 1582. Legacy I/O devices 1615 are coupled to the chipset 1590.

Referring now to FIG. 17, shown is a block diagram of a SoC 1700 in accordance with an embodiment of the present invention. Similar elements bear like reference numerals. Also, dashed lined boxes are optional features on more advanced SoCs. In FIG. 17, an interconnect unit(s) 1702 is coupled to: an application processor 1710 which includes a set of one or more cores 1802A-N and shared cache unit(s) 1806; a system agent unit 1810; a bus controller unit(s) 1816; an integrated memory controller unit(s) 1814; a set or one or more media processors 1720 which may include integrated graphics logic 1808, an image processor 1724 for providing still and/or video camera functionality, an audio processor 1726 for providing hardware audio acceleration, and a video processor 1728 for providing video encode/decode acceleration; an static random access memory (SRAM) unit 1730; a direct memory access (DMA) unit 1732; and a display unit 1740 for coupling to one or more external displays.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code may be applied to input data to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks (compact disk read-only memories (CD-ROMs), compact disk rewritables (CD-RWs)), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

Accordingly, embodiments of the invention also include non-transitory, tangible machine-readable media containing instructions the vector friendly instruction format or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

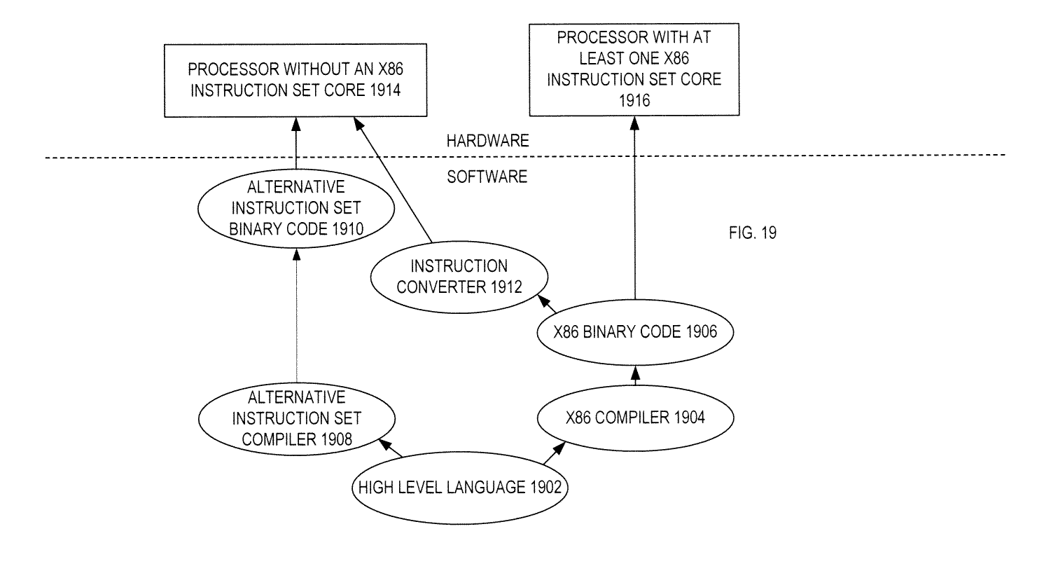

FIG. 19 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 19 shows a program in a high level language 1902 may be compiled using an x86 compiler 1904 to generate x86 binary code 1906 that may be natively executed by a processor with at least one x86 instruction set core 1916 (it is assume that some of the instructions that were compiled are in the vector friendly instruction format). The processor with at least one x86 instruction set core 1916 represents any processor that can perform substantially the same functions as a Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1904 represents a compiler that is operable to generate x86 binary code 1906 (e.g., object code) that can, with or without additional linkage processing, be executed on the processor with at least one x86 instruction set core 1916. Similarly, FIG. 19 shows the program in the high level language 1902 may be compiled using an alternative instruction set compiler 1908 to generate alternative instruction set binary code 1910 that may be natively executed by a processor without at least one x86 instruction set core 1914 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1912 is used to convert the x86 binary code 1906 into code that may be natively executed by the processor without an x86 instruction set core 1914. This converted code is not likely to be the same as the alternative instruction set binary code 1910 because an instruction converter capable of this is difficult to make; however, the converted code will accomplish the general operation and be made up of instructions from the alternative instruction set. Thus, the instruction converter 1912 represents software, firmware, hardware, or a combination thereof that, through emulation, simulation or any other process, allows a processor or other electronic device that does not have an x86 instruction set processor or core to execute the x86 binary code 1906.

Certain operations of the instruction(s) in the vector friendly instruction format disclosed herein may be performed by hardware components and may be embodied in machine-executable instructions that are used to cause, or at least result in, a circuit or other hardware component programmed with the instructions performing the operations. The circuit may include a general-purpose or special-purpose processor, or logic circuit, to name just a few examples. The operations may also optionally be performed by a combination of hardware and software. Execution logic and/or a processor may include specific or particular circuitry or other logic responsive to a machine instruction or one or more control signals derived from the machine instruction to store an instruction specified result operand. For example, embodiments of the instruction(s) disclosed herein may be executed in one or more the systems of FIGS. 14-17 and embodiments of the instruction(s) in the vector friendly instruction format may be stored in program code to be executed in the systems. Additionally, the processing elements of these figures may utilize one of the detailed pipelines and/or architectures (e.g., the in-order and out-of-order architectures) detailed herein. For example, the decode unit of the in-order architecture may decode the instruction(s), pass the decoded instruction to a vector or scalar unit, etc.

The above description is intended to illustrate preferred embodiments of the present invention. From the discussion above it should also be apparent that especially in such an area of technology, where growth is fast and further advancements are not easily foreseen, the invention can may be modified in arrangement and detail by those skilled in the art without departing from the principles of the present invention within the scope of the accompanying claims and their equivalents. For example, one or more operations of a method may be combined or further broken apart.

### Alternative Embodiments

While embodiments have been described which would natively execute the vector friendly instruction format, alternative embodiments of the invention may execute the vector friendly instruction format through an emulation layer running on a processor that executes a different instruction set (e.g., a processor that executes the MIPS instruction set of MIPS Technologies of Sunnyvale, Calif., a processor that executes the ARM instruction set of ARM Holdings of Sunnyvale, Calif.). Also, while the flow diagrams in the figures show a particular order of operations performed by certain embodiments of the invention, it should be understood that such order is exemplary (e.g., alternative embodiments may perform the operations in a different order, combine certain operations, overlap certain operations, etc.).

In the description above, for the purposes of explanation, numerous specific details have been set forth in order to provide a thorough understanding of the embodiments of the invention. It will be apparent however, to one skilled in the art, that one or more other embodiments may be practiced without some of these specific details. The particular embodiments described are not provided to limit the invention but to illustrate embodiments of the invention. The scope of the invention is not to be determined by the specific examples provided above but only by the claims below.

What is claimed is:

1. A method of performing a jump near if the writemask is zero (JKZD) instruction in a computer processor, comprising:
fetching the JKZD instruction, wherein the JKZD instruction includes a writemask operand and relative offset;
decoding the fetched JKZD instruction;
executing the fetched JKZD instruction to conditionally jump to an address of a target instruction when all of bits of the writemask are zero, wherein the address of the target instruction is calculated using an instruction pointer of the JKZD instruction and the relative offset.

2. The method of claim 1, wherein the writemask is a 16-bit register.

3. The method of claim 1, wherein the relative offset is an 8-bit immediate value.

4. The method of claim 1, wherein the relative offset is a 32-bit immediate value.

5. The method of claim 1, wherein the instruction pointer of the JKZD instruction is stored in an EIP register.

6. The method of claim 1, wherein the instruction pointer of the JKZD instruction is stored in a RIP register.

7. The method of claim 1, wherein the executing further comprises:
generating a temporary instruction pointer, wherein the temporary instruction pointer is the instruction pointer of the JKZD instruction plus the relative offset;
setting the temporary instruction pointer to be the address of the target instruction when the temporary instruction pointer is not outside of a code segment limit of a program including the JKZD instruction; and
generating a fault when the temporary instruction pointer to be the address of the target instruction when the temporary instruction pointer is outside of the code segment limit of the program including the JKZD instruction.

8. The method of claim 7, wherein the executing further comprises:
clearing the upper two bytes of the temporary instruction pointer when the operand size of the JKZD instruction is 16 bits prior to setting the temporary instruction pointer to be the address of the target instruction when the temporary instruction pointer is not outside of a code segment limit of a program including the JKZD instruction.

9. A method of performing a jump near if the writemask is not zero (JKNZD) instruction in a computer processor, comprising:
fetching the JKNZD instruction, wherein the JKNZD instruction includes a writemask operand and relative offset;
decoding the fetched JKNZD instruction;
executing the fetched JKNZD instruction to conditionally jump to an address of a target instruction when at least a bit of the writemask in not zero, wherein the address of the target instruction is calculated using an instruction pointer of the JKNZD instruction and the relative offset.

10. The method of claim 9, wherein the writemask is a 16-bit register.

11. The method of claim 9, wherein the relative offset is an 8-bit immediate value.

12. The method of claim 9, wherein the relative offset is a 32-bit immediate value.

13. The method of claim 9, wherein the instruction pointer of the JKNZD instruction is stored in an EIP register.

14. The method of claim 9, wherein the instruction pointer of the JKNZD instruction is stored in a RIP register.

15. The method of claim 9, wherein the executing further comprises:
generating a temporary instruction pointer, wherein the temporary instruction pointer is the instruction pointer of the JKNZD instruction plus the relative offset;
setting the temporary instruction pointer to be the address of the target instruction when the temporary instruction pointer is not outside of a code segment limit of a program including the JKNZD instruction; and
generating a fault when the temporary instruction pointer to be the address of the target instruction when the temporary instruction pointer is outside of the code segment limit of the program including the JKNZD instruction.

16. The method of claim 15, wherein the executing further comprises:
clearing the upper two bytes of the temporary instruction pointer when the operand size of the instruction is 16 bits prior to setting the temporary instruction pointer to be the address of the target instruction when the temporary instruction pointer is not outside of a code segment limit of a program including the JKNZD instruction.

17. An apparatus comprising;
a hardware decoder to decode
a jump near if the writemask is zero (JKZD) instruction, wherein the JKNZD instruction includes a first writemask operand and a first relative offset, and
a jump near if the writemask is not (JKNZD), wherein the JKNZD instruction includes a second writemask operand and second relative offset; and
execution logic to execute decoded JKZD and JKNZD instructions, wherein an execution of a decoded JKZD instruction to cause a conditional jump to an address of a first target instruction when all of bits of the first writemask are zero, wherein the address of the first target instruction is calculated using an instruction pointer of the JKZD instruction and the fisrrt relative offset, and an execution of a decoded JKNZD instruction to cause a conditional jump to an address of a second target instruction when at least a bit of the second writemask in not zero, wherein the address of the second target instruction is calculated using an instruction pointer of the JKNZD instruction and the second relative offset.

18. The apparatus of claim 18, wherein the execution logic comprises vector execution logic.

19. The apparatus of claim 18, wherein the writemasks of the JKZD and JKNZD are dedicated 16-bit registers.

20. The apparatus of claim 18, wherein the instruction pointers of the JKZD and JKNZD instructions are stored in an EIP register.
